(19) United States
(12) Patent Application Publication
(10) Pub. No.: US 2015/0060360 A1
(43) Pub. Date: Mar. 5, 2015

(54) SYSTEMS AND METHODS OF MEMBRANE SEPARATION

(71) Applicant: DXV WATER TECHNOLOGIES, LLC, Orange, CA (US)

(72) Inventors: Michael Sean Motherway, Orange, CA (US); Diem Xuan Vuong, Orange, CA (US); Curtis Roth, Orange, CA (US)

(21) Appl. No.: 14/388,785

(22) PCT Filed: Mar. 15, 2013
(86) PCT No.: PCT/US2013/032456

§ 371 Date: Sep. 26, 2014

Related U.S. Application Data
(60) Provisional application No. 61/623,088, filed on Apr. 12, 2012.

(51) Int. Cl. C02F 1/44; B01D 63/10; B01D 65/08; B01D 63/12

(52) U.S. Cl. CPC C02F 1/44; B01D 63/12; B01D 63/10; B01D 65/08
USPC 210/639; 210/196; 210/497.1

(57) ABSTRACT

Water treatment systems and methods are provided to minimize membrane fouling and the required maintenance that results therefrom. A water treatment system includes a pressure vessel with a plurality of spaced-apart membranes circularly disposed therein, and an impeller or other means for circulating feed water through the interior of the vessel and past the membranes. Antifouling particles (such as diatomaceous earth or activated carbon) and/or pellets can be added to the feed water inhibit membrane fouling and extend the useful life of the membranes. A feed spacer element having a window-pane pattern can be disposed between adjacent membrane leaves to reduce membrane fouling.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference under 37 CFR 1.57.

This application claims the benefit under 35 U.S.C. §119(e) of U.S. Provisional Patent Application No. 61/623,088, filed on Apr. 12, 2012, which is hereby incorporated by reference in its entirety.

### BACKGROUND OF THE INVENTION

1. Field of the Invention

This application relates to the field of water and waste water treatment. More particularly, this application relates to a membrane system for treating water and waste water.

2. Description of the Related Art

While there are many methods to remove impurities from water, membrane treatment is becoming far more common as technologies improve and water sources become more contaminated. Membrane treatment entails providing a pressure differential across a semi-permeable membrane. The differential allows relatively smaller water molecules to flow across the membrane while relatively larger contaminants remain on the high pressure side. As long as the contaminants are larger than the pores in the membrane, they can be effectively filtered out by the membrane and removed with the concentrate. Some membranes combine size exclusion with electrostatic repulsion as in the case of reverse osmosis and nanofiltration membranes.

Different membranes can be used for different raw water sources and treatment goals. Classifications of membranes generally fall into four broad categories, generally defined by the size of contaminants screened out by the membrane. This size can loosely be correlated to the pore size in the membrane. The four broad categories of membranes are, in decreasing order of the size of materials screened, microfiltration (MF) membranes (which are capable of screening materials with atomic weights between about 80,000 and about 10,000,000 Daltons); ultrafiltration (UF) membranes (which are capable of screening materials with atomic weights between about 5,000 and about 400,000 Daltons); nanofiltration (NF) membranes (which are capable of screening materials with atomic weights between about 180 and about 15,000 Daltons); and reverse osmosis (RO) membranes (which are capable of screening materials with atomic weights between about 30 and about 700 Daltons).

MF and UF membrane systems are typically operated under positive pressures of, for example, 3 to 40 psi, or under negative (vacuum) pressures of, for example, −3 to −12 psi, and can be used to remove particulates and microbes. MF and UF membranes may be referred to as “low-pressure membranes.” NF and RO membranes, in contrast, are typically operated at higher pressures than MF and UF membrane systems, and can be used to remove dissolved solids, including both inorganic and organic compounds, from aqueous solutions. NF and RO membranes may be referred to as “osmotic membranes.” Osmotic membranes are generally charged, adding to their ability to reject contaminants based not only on pore size but also on the repulsion of oppositely-charged contaminants such as many common dissolved solids. Reverse osmosis (RO), nanofiltration (NF) and, to some extent, ultrafiltration (UF) membranes can be used in cross-flow filtration systems which operate in continuous processes (as opposed to batch processes) at less than 100% recovery.

Reverse Osmosis is a membrane process that acts as a molecular filter to remove 95 to 99% of dissolved salts and inorganic molecules, as well as organic molecules. Osmosis is the natural process which occurs when water or another solvent spontaneously flows from a less-concentrated solution, through a semi-permeable membrane, and into a more concentrated solution. In Reverse Osmosis the natural osmotic forces are overcome by applying an external pressure to the concentrated solution (feed). Thus the flow of water is reversed and desalinated water (permeate) is removed from the feed solution, leaving a more concentrated salt solution (brine). Product water quality can be further improved by adding a second pass of membranes, whereby product water from the first pass is fed to the second pass. In a reverse osmosis process as is typically commercially employed, pretreated seawater is pressurized to between 850 and 1,200 pounds per square inch (psi) (5,861 to 8,274 kPa) in a vessel housing, e.g., a spiral-wound reverse osmosis membrane. Seawater contacts a first surface of the membrane, and through application of pressure, potable water penetrates the membrane and is collected at the opposite side. The concentrated brine generated in the process, having a salt concentration up to about twice that of seawater, is disposed back into the ocean.

RO and NF membranes can be composed of a thin film of polyamide deposited on sheets of polysulfone or other substrate. One common form of RO or NF membrane is a thin film composite flat sheet membrane that is wound tightly into a spiral configuration. UF membranes are more commonly provided as hollow fiber membranes, but can also be used in spiral wound elements. The spiral elements make efficient use of the volume in a pressure vessel by tightly fitting a large area of membrane into a small volume. A spiral element typically consists of leaves of back to back flat sheet membranes adjoining a perforated tube. Between the back to back membranes of each leaf is a permeate carrier sheet that conveys the treated water around the spiral (through the leaf) to the central perforated collection tube. A feed water spacer is wound into the spiral to separate adjacent leaves (and/or keep the same leaf from touching itself upon winding). After the leaves are wound against each other they are as close together as about 0.5 to 0.8 millimeters (about the thickness of the physical feed (raw water) spacer that is rolled up with the membrane leaves). The feed water spacer maintains an adequate channel between the membrane leaves so that pressurized feed water can flow between them.

The spiral wound membrane element has become ubiquitous in the field of advanced water treatment and even in non-water separation applications. The spiral membrane element and many supporting components have been designed for the most common applications but there are other applications that call for alternative designs of the components that go with the spiral membrane element. Specifically, the pressure vessel traditionally used for a spiral wound membrane element is designed for several elements in-line.

Spiral membrane elements are traditionally oriented horizontally and the feed water travels through the membranes one time and the concentrate is what is left at the end of the vessel. However, the once-through paradigm is not necessary for a spiral membrane system, so an alternative vessel design is possible for re-circulating feedwater systems. A much larger diameter vessel can array the spiral elements in parallel rather than in series. Access to the interior of the pressure vessel is a concern for these large vessels as an opening the size of the entire diameter would be extremely unwieldy and expensive. These large vessels typically have a large openings and heavy caps. When access is required for a large opening it requires an expensive connection and the heavy cap requires lifting devices such as forklifts or cranes.

Fouling is the single greatest maintenance issue associated with membrane water treatment. Fouling occurs when contaminants in the water adhere to the membrane surfaces and/or lodge into the membrane pores. Fouling creates a pressure loss in the treatment process, increasing energy costs and reducing system capacity. Numerous cleaning methods have been developed to de-foul membranes but they are complex, require significant downtime and often do not fully restore the flux of the membranes.

### SUMMARY OF THE INVENTION

Embodiments of the invention provide water treatment systems and methods that minimize membrane fouling and the required maintenance that results therefrom. Embodiments of the invention also significantly reduce cost and complexity of membrane separation systems. In some embodiments, spiral membrane elements may be situated in a specially designed pressure vessel having unique components for loading and restraining the spiral membrane elements in the vessel. In some embodiments, when the membranes are not oriented in-line the pressure vessels can be differently shaped than the more traditional cylinder shapes. In some embodiments, such as in re-circulated systems, the water passes through the membrane elements several times. In some embodiments, the membrane elements do not need to be oriented in-line but can be situated in parallel. In some embodiments, spiral membrane elements can be side by side, bunched like cigarettes in a pack, where the feed water travels through them in parallel as well as in series. In some embodiments, a membrane system arrays spiral membranes in a large diameter pressure vessel with a feed water circulation system to move the water through a return loop in the same vessel. In some embodiments, the return can be an area void of membrane elements where the water flows one direction through the return and the other direction through the elements. In some embodiments, the entire vessel cross section can be packed with membrane elements with the flow moving opposite directions through half of the elements. In some embodiments, mechanisms may be used that allow a large diameter vessel to only require a small diameter access opening to load and unload individual membrane elements.

One embodiment is a system for treating liquid comprising membrane foulants. The system includes a cylindrical pressure vessel configured to hold a volume of the liquid and having an inlet, a concentrate outlet, and a permeate outlet, a plurality of spiral wound membrane elements disposed within the cylindrical pressure vessel, and a circulator configured to circulate the liquid in the cylindrical pressure vessel in a direction generally parallel to a membrane surface of the membrane elements, wherein the plurality of spiral wound membrane elements are arranged in a circular array vertically within the cylindrical pressure vessel and tangential to both adjacent spiral wound membrane elements and an interior wall of the cylindrical pressure vessel such that the plurality of spiral wound membrane elements are arrayed surrounding a circulation return and the liquid flows in one direction through the circulation return and the other direction through the spiral wound membrane elements.

Another embodiment is a spiral wound membrane element for water treatment that includes at least one membrane leaf connected to a perforated permeate collection tube, the membrane leaf having a membrane surface and a spacer element disposed adjacent to the at least one membrane leaf to keep the membrane surface separated from adjacent membrane surfaces when the membrane leaf is wound. The spacer element further comprises a pattern of voids such that the voids create areas within the membrane element where neither adjacent membrane surfaces nor spacer element touch the membrane surface.

Yet another embodiment is a method for manufacturing a spiral wound membrane element for water treatment. The method includes the steps of selecting a continuous feed water spacer element sheet, cutting a pattern of voids in the spacer element sheet, selecting a membrane leaf, and rolling the spacer element sheet and the membrane leaf to obtain the spiral wound membrane element.

One other embodiment is a spacer element disposed between adjacent leaves of a spiral wound membrane element. The spacer element includes a continuous sheet of spacer material with die cut voids similar to a window pane pattern, wherein the die cut voids reduce the spacer material in contact with a surface of the membrane element and prevent adjacent membrane surfaces from touching.

Yet another embodiment is a method of treating an aqueous liquid containing membrane foulants, the method including the steps of periodically adding antifouling particles to the liquid, the antifouling particles having a specific surface area of 10 m²/g or more, supplying the liquid to a pressure vessel, the pressure vessel having an inlet, a concentrate outlet, a permeate outlet, and a plurality of spiral wound membrane elements vertically and tangentially disposed in a circle within the pressure vessel surrounding a circulation return, applying a pressure differential across the spiral wound membrane elements, circulating the liquid past the spiral wound membrane elements in the pressure vessel, and collecting permeate from the permeate outlet.

### BRIEF DESCRIPTION OF THE DRAWINGS

FIG. 1 is a horizontal cross section of a water treatment system according to an embodiment, comprising an array of several spiral membrane elements arrayed vertically within a pressure vessel.

FIG. 2 is a perspective view of the pressure vessel and spiral membrane elements shown in FIG. 1.

FIG. 3 is another embodiment of a pressure vessel for a water treatment system.

FIG. 4 is a vertical cross section of a water treatment system configured with a circulation system, according to one embodiment.

FIG. 5 is a vertical cross section of a water treatment system illustrating the flow directions within a pressure vessel.

FIG. 6 is a perspective view of another embodiment of a pressure vessel of a water treatment system with stacked spiral membrane elements, according to one embodiment.

FIG. 7 is a plan view cross section of a second pressure vessel of a water treatment system with two concentric arrays of membrane elements around a central return flow path, according to one embodiment.

FIG. 8 is a plan view cross section of a third pressure vessel of a water treatment system with three concentric arrays of membrane elements around a central return flow path, according to one embodiment.

FIG. 9A is a plan view cross section of a pressure vessel of a water treatment system containing a single membrane element.

FIG. 9B is a perspective view of the water treatment system shown in FIG. 9A.

FIG. 9C is a vertical cross section of the water treatment system shown in FIG. 9A illustrating the flow paths and a supporting wire floor.

FIG. 10 is a plan view cross section of a pressure vessel for a water treatment system having two openings.

FIG. 11 is a plan view cross section of a pressure vessel for a water treatment system having three tracks on which membrane elements can be loaded, according to one embodiment.

FIG. 12 is a schematic diagram illustrating a spiral wound membrane element containing a central permeate tube according to one embodiment.

FIG. 13A is one embodiment of a plug for a permeate tube.

FIG. 13B is another embodiment of a plug for a permeate tube.

FIG. 13C is an embodiment of a permeate plug and rail rider system, according to one embodiment.

FIG. 14A is anti-fouling particles in suspension in a pressure vessel.

FIG. 14B is anti-fouling particles that have settled on the bottom of a pressure vessel.

FIG. 15 is a schematic diagram of an operating mode, according to one embodiment.

FIG. 16 is a schematic diagram of an operating mode, according to another embodiment.

FIG. 17 is a vertical cross section of a pressure vessel for a water treatment system illustrating the collection pipes and manifolds, according to one embodiment.

FIG. 18 is a vertical cross section of another embodiment of a pressure vessel for a water treatment system illustrating the use of a submersible pump to circulate the feed water.

FIG. 19 is a horizontal cross section of a pressure vessel for a water treatment system illustrating a flow restricting plate divided into several sections.

FIG. 20 is a perspective view of a spiral wound membrane element, according to an embodiment.

FIG. 21 is a view of a feed spacer web, according to an embodiment.

FIG. 22 is a cross section of a spiral wound membrane element attached to a permeate collector tube, according to one embodiment.

FIG. 23A is a cross section of the membrane element shown in FIG. 22 showing spacer elements disposed in a horizontally-oriented membrane element, according to an embodiment.

FIG. 23B is a cross section of the membrane element shown in FIG. 22 showing spacer elements disposed in a vertically-oriented membrane element, according to an embodiment.

FIG. 24 is a view of a membrane element and permeate tube prior to being wound, according to one embodiment.

FIG. 25 is a cross section of the membrane element of FIG. 24.

FIG. 26 is a view of a membrane element, according to another embodiment.

FIG. 27 is a view of a membrane element, according to yet another embodiment.

FIG. 28A is a cross section of the membrane element shown in FIG. 26, according to one embodiment.

FIG. 28B is a cross section of the membrane element shown in FIG. 27, according to another embodiment.

FIG. 29 is a view of a feed water spacer sheet, according to one embodiment.

FIG. 30 is a cross section of a feed water spacer sheet, according to another embodiment.

FIG. 31 is a view of a feed water spacer sheet, according to another embodiment.

FIG. 32 is a view of a feed water spacer sheet, according to yet another embodiment.

### DETAILED DESCRIPTION OF THE PREFERRED EMBODIMENT

The features, aspects and advantages of the present invention will now be described with reference to the drawings of several embodiments, which are intended to be within the scope of the invention herein disclosed. These and other embodiments will become readily apparent to those skilled in the art from the following detailed description of the embodiments having reference to the attached figures, the invention not being limited to any particular embodiment(s) disclosed.

Conventional reverse osmosis desalination plants expose reverse osmosis membranes to high-pressure saltwater. This pressure forces water through the membrane while preventing (or impeding) passage of ions, selected molecules, and particulates therethrough. Desalination processes are typically operated at a high pressure, and thus have a high energy demand. Various desalination systems are described in U.S. Pat. No. 3,060,119 (Carpenter); U.S. Pat. No. 3,456,802 (Cole); U.S. Pat. No. 4,770,775 (Lopez); U.S. Pat. No. 5,229,005 (Fok); U.S. Pat. No. 5,366,635 (Watkins); and U.S. Pat. No. 6,656,352 (Bosley); and U.S. Patent Application No. 2004/0108272 (Bosley); the disclosures of each of which are hereby incorporated by reference in their entireties.

Systems are provided for purifying and/or desalinating water. The systems involve exposure of one or more membranes, such as nanofiltration (NF) or reverse osmosis (RO) membranes, to hydrostatic pressure. The membrane is subjected to a pressure that is sufficient to overcome the sum of the osmotic pressure of the feed water (or raw water) that exists on the first side of the membrane and the transmembrane pressure loss of the membrane itself. For seawater or other water containing higher amounts of dissolved salts, transmembrane pressure losses are typically much smaller than the osmotic pressure. Thus, in some applications, osmotic pressure is a more significant driver than transmembrane pressure losses in determining the required pressure. In treatment of lower salt lake or river water osmotic pressures tend to be lower, and the transmembrane pressure losses become a more significant factor in determining the required pressure. Typically, systems adapted for desalinating seawater require greater pressures than do systems for treating freshwater or wastewater.

The systems of preferred embodiments utilize membrane modules of various configurations. In a preferred configuration, the membrane module employs a membrane system wherein two parallel membrane sheets are held apart by permeate spacers, and wherein the volume between the membrane sheets is enclosed. Permeate water passes through the membranes and into the enclosed volume, where it is collected. Particularly preferred embodiments employ rigid separators to maintain spacing between the membranes on the low pressure (permeate) side; however, any suitable permeate spacer configuration (e.g., spacers having some degree of flexibility or deformability) can be employed which is capable of maintaining a separation of the two membrane sheets. The spacers can have any suitable shape, form, or structure capable of maintaining a separation between membrane sheets, e.g., square, rectangular, or polygonal cross section (solid or at least partially hollow), circular cross section, I-beams, and the like. Spacers can be employed to maintain a separation between membrane sheets in the space in which permeate is collected (permeate spacers), and spacers can maintain a separation between membrane leaves (two back to back membrane sheets enclosing a permeate carrier or spacer) in the area exposed to raw or untreated water (e.g., raw water spacers). Alternatively, configurations can be employed that do not utilize raw water spacers. Instead, separation is provided by the structure that holds the membranes in place, e.g., the supporting frame. Separation can also be provided by, e.g., a series of spaced expanded plastic media (e.g., spheres), corrugated woven plastic fibers, porous monoliths, nonwoven fibrous sheets, or the like. Similarly, the spacer can be fabricated from any suitable material. Suitable materials can include rigid polymers, ceramics, stainless steel, composites, polymer coated metal, and the like. As discussed above, spacers or other structures providing spacing are employed within the space between the two membrane surfaces where permeate is collected (e.g., permeate spacers), or between membrane surfaces exposed to raw water (e.g., raw water spacers).

The spiral wound membrane may be a polymeric membrane. The most common polymers used in membrane fabrication include cellulose acetate, Nitrocellulose, cellulose esters, polysulfone, polyether sulfone, polyacrilonitrile, polyamide, polyimide, polyethylene and polypropylene, polytetrafluoroethylene, polyvinylidene fluoride, and polyvinylchloride. In some embodiments, reverse osmosis membranes may be made from cellulose acetate, aromatic polyamide, and polyimide materials. In some embodiments, the spiral wound membrane may be an osmotic polymeric thin film composite membrane.

Membrane-based water treatment processes often employ two or more filtration methods in stages to minimize membrane fouling in the later stage. As an example, a reclaimed water treatment system might include a sand or media filter stage followed by a microfiltration (MF) membrane treatment stage and then a reverse osmosis (RO) membrane stage that receives product water from the MF membrane stage as input. Contaminants larger than the membrane pores can lodge in the pores and block the flow of water through the membrane in either stage. When this occurs the membrane is said to be fouled. Membrane fouling can be caused by particulates (e.g., silts, clays, etc.), biological organisms (e.g., algae, bacteria, etc.), dissolved organic compounds (e.g., natural organic matter), or precipitation of dissolved inorganic compounds (e.g., calcium, magnesium, manganese, etc.).

Membrane productivity can also decrease as dissolved solids increase in concentration in the feed water. An increase in concentration of dissolved solids near the membrane surface raises the osmotic pressure requirement. For a given feed pressure, this can result in a reduction in the effective driving pressure and a lower flux rate.

Another source of fouling is scaling, which can occur when dissolved solids increase in concentration to the point of precipitation. Scale formation can block the membrane and reduce productivity.

In some embodiments, the membranes comprise ultrafiltration (UF), nanofiltration (NF) and reverse osmosis (RO) membranes which are relatively much tighter and smoother than microfiltration (MF) membranes. With pore sizes much smaller than typical MF membranes, these membranes do not allow large contaminants to lodge in their pores. In addition, NF and RO membranes, which are often charged, can remove varying amounts of dissolved solids from the feed water stream. RO membranes are usually capable of removing more dissolved solids than nanofiltration membranes. In some embodiments, use of NF and RO membranes involves higher driving pressures than MF or UF membranes, resulting in a lower flux.

For example, in some embodiments, feed water velocity can be raised by re-circulating water past the membranes inside the pressure vessel. Rather than removing the feed water from the pressure vessel at one end and pumping it back to the other end via an external conduit or circuit, in embodiments of the invention, the feed water is routed through open areas inside the pressure vessel (areas not occupied by membrane or membrane cartridges) via baffles that direct the water flow around the membrane cartridge(s). For example, frustoconical baffles can be disposed at one end of the membrane cartridges so as to direct the feed water toward a circulator, such as, for example, a pump or a rotating impeller. The impeller can be configured and positioned to draw feed water flowing between the membrane elements, and redirect that water around the baffles, through the open areas inside the pressure vessel, and back to the other end of the membrane cartridge(s). Recirculating the feed water within the vessel results in less pressure loss than in conventional systems that redirect feed water into a smaller-aperture circuit outside the vessel.

In some embodiments, antifouling particles can be added to a contaminated feed water supply to inhibit or prevent membrane fouling, extending the time between periodic membrane cleanings, and extending the useful life of the membranes. In suspension, the antifouling particles can absorb and/or adsorb (i.e., attract and hold) smaller contaminant particles which might otherwise coat the membrane surfaces and block the flow of permeate through the membrane surfaces. The antifouling particles can also coat the membrane surfaces to form a water-permeable protective structure (or layer) over the membrane surfaces. Such a protective structure can attract and hold contaminant particles throughout its thickness, preventing the buildup of a dense, water-impermeable layer close to or on the membrane surfaces. In some embodiments, pellets can be added to the feed water inside the vessel. The pellets can be configured to contact and dislodge contaminant particles which may have built up on the membrane surfaces, inhibiting or preventing the buildup of a nonporous (or low-porosity) layer of contaminant particles on the membrane surface. In embodiments employing both antifouling particles and pellets, the pellets can be configured to contact and dislodge antifouling particles which may have built up on the membrane surfaces, along with any contaminant particles which may have adhered to the antifouling particles. In such an embodiment, the pellets can inhibit or prevent the formation of a contaminant particle “crust” at the surface of the antifouling layer which is exposed to the feed water, improving the performance of the antifouling layer.

Embodiments of the invention can be used as an enhanced pretreatment stage in a multi-stage process to facilitate higher water recovery rates than conventional systems. For example, a system as described herein can be configured with relatively loose NF membranes to target dissolved minerals (calcium, magnesium) as well as dissolved organics and biological contaminants in wastewater plant effluent (i.e., primary effluent as well as secondary or tertiary effluent). Such a system can be installed upstream of a conventional RO system (as the final treatment stage) and configured to deliver an extremely clean feed stream to the RO stage, allowing the RO stage to operate at higher-than-typical recoveries—as high or higher than 90%. In this example, because the concentrate produced in the enhanced pretreatment stage is not highly saline, it can be sent back through the wastewater treatment plant with causing any process problems. In some embodiments, the higher calcium content of the concentrate from the enhanced pretreatment stage can actually facilitate the overall reclaimed water treatment process. Such a pretreatment system can be operated at any appropriate recovery rate. By recycling the concentrate of the enhanced pretreatment stage back to the beginning of the reclaimed water treatment process, a 90 to 95% recovery rate can be achieved for the overall process.

Membrane fouling necessitates higher pressure and, thus, more energy to maintain productivity of the membrane. In the two-stage system described above, the MF membranes of the first stage, which have relatively larger pores than the RO membranes of the second stage, can be cleaned by periodic backwashing, which involves forcing clean water back through the membranes in the opposite direction of the treatment process. This backwashing step takes the membrane system out of operation for the period of the backwash. Less frequent, but lengthier, cleaning processes can involve removal of the membrane elements from their containers and cleaning with chemicals and agitation.

The drawbacks to these cleaning systems are several. First, because the MF first stage does not screen out all potential foulants, the downstream RO stage often still requires significant maintenance. In addition, the MF backwashing stage requires expensive equipment such as automated valves and pumps. This stage also reduces system capacity as product water is used in the cleaning process. These processes require skilled operators to maintain complicated electronic systems and the chemicals used for cleaning require special containment and handling procedures. Embodiments of the present invention avoid membrane fouling, with simple systems that require very little maintenance.

In preferred embodiments, one or more membrane units are arranged in a pressure vessel configured to hold source water to be treated. The membrane units can be disposed in a spaced-apart configuration, such as, for example, a sufficiently spaced configuration to limit or prevent attraction between adjacent membrane units and/or collapse of adjacent membrane units upon each other. Each membrane unit has a feed water side and a permeate side. The feed water side is exposed to the pressure of the vessel and the permeate side is exposed to near atmospheric pressure. The pressure differential between the vessel pressure and atmospheric pressure drives a filtration process across the membranes. In some embodiments, the membrane units or elements are configured in an “open” configuration, with adjacent membrane elements being spaced apart by a greater distance than in conventional osmotic membrane systems, and without a conventional continuous feed water spacer disposed between adjacent active membrane surfaces on the feed water side. Such a configuration can both inhibit settlement of bacteria and/or particles on the membrane and can also reduce longitudinal head loss as compared to conventional systems. In some embodiments, the membrane elements are arrayed vertically within the pressure vessel.

The systems of certain embodiments are advantageous in that they simplify or eliminate certain process steps that would otherwise be necessary in a conventional water treatment plant, such as a plant employing conventional spiral-wound membrane systems. Embodiments can be configured to treat a wide range of source (raw) water, including potable or brackish surface water, potable or brackish well water, seawater, industrial feed water, industrial wastewater, storm water, and municipal wastewater, to produce product water of a quality suitable for a particular desired use, including supplying the product water to particular follow-on treatment process. In addition, the systems described herein can be mounted and/or transported in a vehicle and deployed in emergency situations to remove, e.g., dissolved salts or other unwanted constituents such as viruses and bacteria to produce potable water from a contaminated or otherwise non-potable water supply.

The systems involve exposure of one or more membranes, such as nanofiltration (NF) or reverse osmosis (RO) membranes, to a volume of water held at pressure in a pressure vessel. The vessel pressure can be tailored to the selected membranes and the treatment goals. In embodiments employing an osmotic membrane (one that removes a portion of dissolved solids), for example, the minimum operating pressure required would be the sum of the osmotic pressure differential of the feed water and permeate, the transmembrane pressure, and the longitudinal head loss through the vessel.

The spiral wound membrane elements has become ubiquitous in the field of advanced water treatment and even in non-water separation applications. The spiral membrane element and many supporting components have been designed for the most common applications but there are other applications that call for alternative designs of the components that go with the spiral membrane element. Specifically, the pressure vessel traditionally used for a spiral wound membrane elements is designed for several elements in-line (series). The present invention concerns a specially designed pressure vessel and components for loading and restraining spiral membrane elements in the vessel.

Spiral membrane elements are traditionally oriented horizontally and the feed water travels through the membranes one time and the concentrate is what is left at the end of the vessel. However, the once-through paradigm is not necessary for a spiral membrane system, so an alternative vessel design is possible for a re-circulating feedwater system. When the membranes are not oriented in-line the pressure vessels can be differently shaped than traditional cylindrical shapes. Specifically, in re-circulated systems the water passes through the membrane elements several times so they do not need to be oriented in-line, but can be situated in parallel. Spiral membrane elements can be side by side, bunched like cigarettes in a pack where the feed water travels through them in parallel. The present invention is a membrane system arraying spiral membranes like this in a large diameter pressure vessel with a feed water circulation system to move the water through a return loop in the same vessel. The return can be an area void of membrane elements where the water flows one direction through the return and the other direction through the elements. Alternatively, the entire vessel cross section can be packed with membrane elements with the flow moving opposite directions through half of the elements.

Access to the interior of the pressure vessel is a concern for these large vessels. Access via a large opening requires an expensive connection and a heavy cap requiring lifting devices such as forklifts or cranes. However, the present invention entails mechanisms that allow a large diameter vessel to only require a small diameter access opening to load and unload individual membrane elements.

In preferred embodiments of the invention, a membrane module as described herein can be submerged in a pressure vessel and used to produce potable water from a non-potable supply. The permeate side of the membranes is kept at about atmospheric pressure by a port (not shown) placing the collection system in fluid communication with the atmosphere outside the pressure vessel, via a pipe, tube or other means of transmitting the product water through the side of the pressure vessel to a storage tank or distribution point.

When the membrane module is submerged, pressurized source water in the vessel flows substantially freely through the top, bottom, and rear of each membrane cartridge. The pressure differential between the source water side of the membranes and the permeate side of the membranes causes permeate to flow to the low pressure (permeate) side of the membranes.

In embodiments of the invention, if gravity pressure is not available from a water source at a greater elevation than the system, the pressure differential (between the feed water side and the permeate side of the membranes) can be provided using one or more pumps. In certain embodiments, to contain the high pressure feed water surrounding the membranes, a pressure vessel 2 is provided. Such a vessel can be made of any suitable material such as steel, fiberglass or another composite. The structural configuration of the pressure vessel 2 can vary depending on the treatment goals and the characteristics of the membranes chosen for the particular application. Varying levels of pressure can be provided to remove varying percentages of dissolved solids. For example, with a brackish water source (total dissolved solids at, say, 1,500 mg/l), where the goal is to remove 50% of the solids, tight NF membranes can be used with a feed water pressure of approximately 60 psi. With a soft water source having relatively low dissolved solids (under 100 mg/l), NF membranes can be used, with only 25 psi of feed water pressure. If removal of dissolved solids is not a treatment goal, ultrafiltration (UF) membranes can be selected and used with lower feed water pressures.

One embodiment of the pressure vessel is a cylindrical tank. In some embodiments, in order to accommodate the relatively large volume of the membrane cartridge(s), the vessel or tank can be provided with a rather large gateway or portal, such as a removable lid, in order to allow loading of the membrane elements into the vessel. In other embodiments, a series of relatively smaller membrane cartridges can be loaded through a relatively smaller gateway or portal in the vessel wall, and then moved into position within the tank. In some embodiments, the gateway or portal can comprise a flange with a gasket.

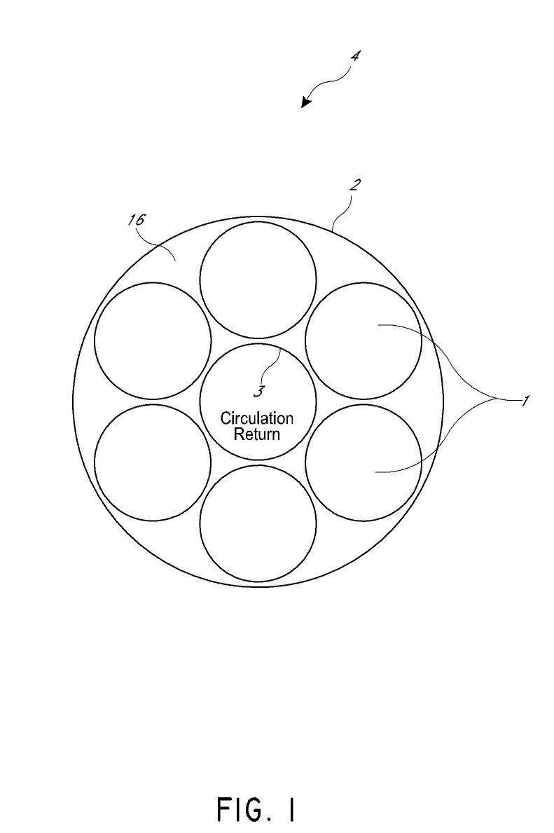

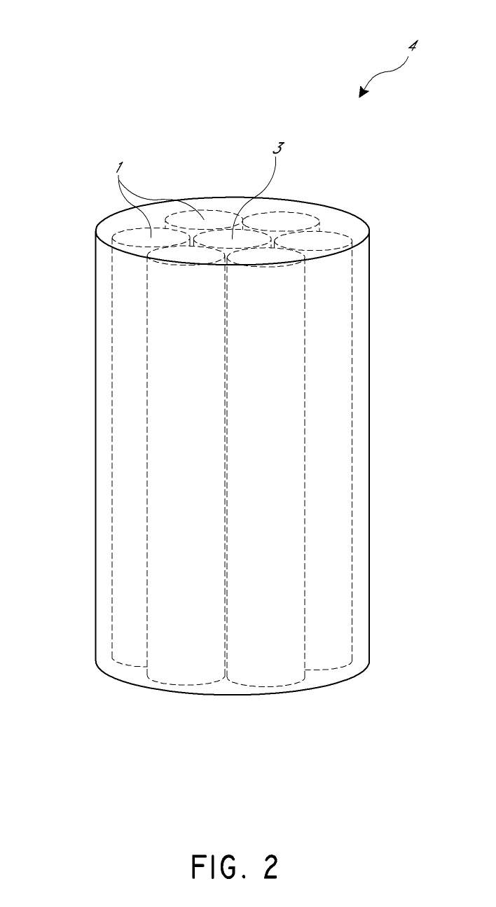

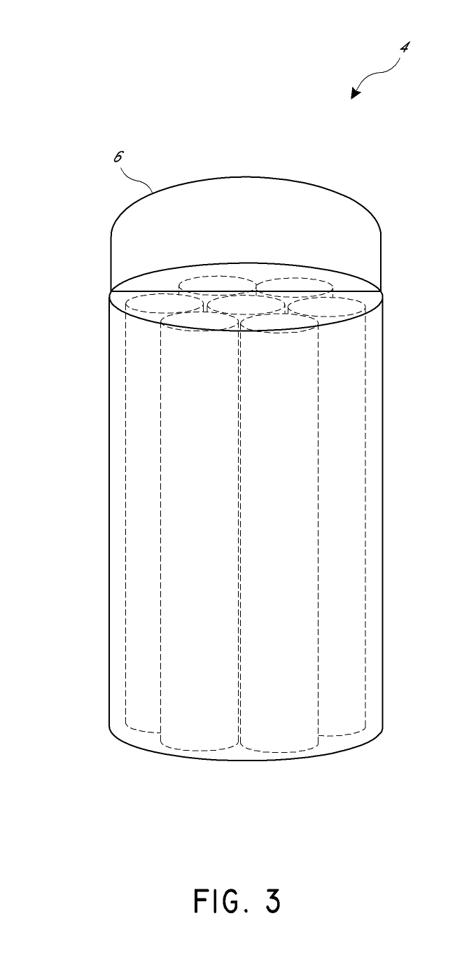

A pressure vessel that can accommodate several spiral membrane elements is disclosed with an in-vessel circulation system designed to provide cross-flow across the membrane elements. One embodiment, shown in FIG. 1, shows such an array in horizontal cross section. FIG. 1 illustrates a pressure vessel 4 containing six spiral membrane elements 1 arrayed vertically that are also tangentially arrayed against the vessel wall 2. A central return path is provided by a cylindrical flow area 3 not containing membrane. A plate 16 that is the shape of the inner diameter of the vessel 4 with cutouts for the membrane elements 1 and the return flow path 3 is also shown. FIG. 2 shows a perspective view of the vessel 4 illustrating the membrane element arrangement of FIG. 1 in three dimensions with the pressure vessel 4 (without a domed top) surrounding the six membrane elements 1 and the central return path 3. FIG. 3 shows the same vessel 4 and membrane element configuration as shown in FIG. 2 with a domed top 6 for structural integrity.

The pressure vessel can also employ a mixer system to move the water through the spiral membrane elements at a desired velocity. In some embodiments, one or more impellers or propellers can be disposed inside the vessel and configured to produce circulation of feed water past the surfaces of the membrane cartridges disposed inside the pressure vessel. One or more baffles can also be disposed inside the pressure vessel and configured to cooperate with the impeller or impellers to direct feed water in certain desired direction. The baffles can have any suitable shape and configuration within the vessel in order to, in combination with the impeller or impellers, create or encourage a general recirculatory flow path of the feed water through the vessel and past the membrane surfaces. The impeller can be configured to pull feed water from the membrane cartridges through and around the baffles. Such movement of the water will create a circulation of the water around and between the membranes. This circulation of the feed water will increase the cross-flow velocity past the membrane surfaces, thereby inhibiting particle settlement on the membrane elements. The impeller can be made of any suitable material such as, for example, stainless steel, plastic, fiberglass or carbon fiber. The impeller can have any number, shape, and orientation of blades consistent with its intended purpose. The impeller can be driven by a motor residing either inside the tank or outside the tank, with, for example, a sealed drive shaft penetrating the tank wall. The impeller can be configured to move a high volume of water at a low pressure.

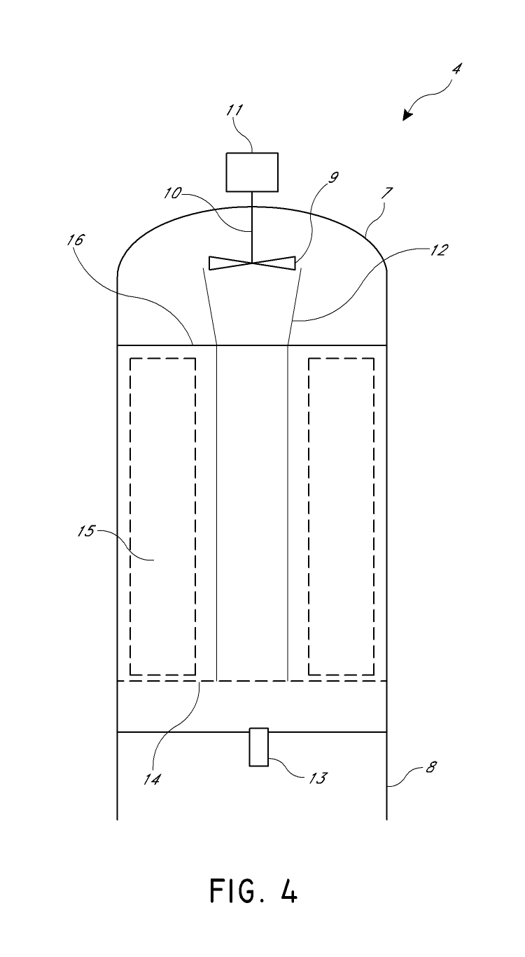

One embodiment, shown in FIG. 4, shows the cross section of a vessel outfitted with such a circulation system. The vessel 4 may be outfitted with a cap 7 with a penetrating shaft 10 with an impeller 9. The impeller 9 may be driven by an external motor 11. The interior of the vessel 4 may be outfitted with flow directing baffles 12 that direct the water flow to the impeller 9. The vessel 4 may be outfitted with legs 8 to allow it to be outfitted with a drain valve 13 on the bottom in order to easily vacate solids that might settle on the interior bottom of the vessel 4. The interior of the vessel 4 also may include a floor 14 made of wire mesh (coated like a dishwasher rack) that supports the membranes 15 but also allows water to easily pass through. A plate 16 that is the shape of the inner diameter of the vessel 4 with cutouts for the membrane elements 15 and the return flow path baffle 12 is shown.

FIG. 5 shows the vessel 4 as shown in FIG. 4 with the flow directions noted by arrows 110, 112, 116, and 118. The impeller 9 draws the water up through the central flow path formed by the internal baffles 12, down through the membranes 15, and through the floor 14 supporting the membranes 15. The velocity of the water flowing through the vessel 4 is determined by the flow path area. The nominal flow area is determined by membrane cross section and the fullness of the feed water spacer sheet. A full feed spacer will restrict flow more than a relatively open one.

By recirculating or recycling feed water through the pressure vessel, a higher velocity is generated in the feed water past the membranes, assisting in preventing contaminants from settling on the membranes. In conventional systems, the cross flow velocity is generally determined by the recovery and flux of the system. In embodiments of the invention, by circulating the feed water past the membranes at higher velocities than would be dictated by the recovery and flux alone, better mixing and increased membrane surface scouring can be achieved. For example and without limitation, the cross-flow velocity in embodiments can be greater than 0.5 feet per second, greater than 1.0 feet per second, greater than 2.0 feet per second, greater than 3.0 feet per second, or greater than 5.0 feet per second. In some embodiments, the cross-flow velocity can be between about 0.5 and about 10.0 feet per second, between about 1.0 foot per second and about 2.0 feet per second, or between about 2.0 feet per second and about 3.0 feet per second. The recirculation or recycle rate in embodiments can also vary depending on the particular application and depending on the operator's particular goals. As an example, a system with a fresh surface water source having low total dissolved solids (TDS) and low turbidity can be operated at an 80% recovery rate with a relatively high recycle rate and a relatively high flux. The same system can also be operated at a lower recovery, with a lower recycle rate to save energy, or with the same or higher recycle rate to reduce membrane cleaning requirements. This added operational parameter (i.e., recirculation rate or recycle rate) also facilitates periodic system adjustments without interrupting production. For example, to accommodate seasonal variations in feed water quality, the recycle rate can be increased as the fouling potential of the feed water increases. This allows for a single configuration to treat nearly any source of water with only minor operational adjustments. Generally speaking, in once-through systems, the higher the recovery, the greater the reduction in feed water velocity as the feed water travels longitudinally past the membranes. By employing a recirculation system, embodiments of the invention can serve to even out the feed water velocity over the length of the membranes. In embodiments, the feed water is circulated through the vessel (and past the membranes) multiple times, reducing the recovery rate per pass. For example, for a conventional system with a 50 percent overall recovery, the velocity at the end of membrane circuit is roughly one half of the velocity at the feed water inlet. In an embodiment that adds a recirculation pass, operating at an overall recovery rate of 50%, the recovery per pass is half the overall recovery, or 25%. In such a system, the velocity at the end of the membrane circuit would be three-quarters of the velocity at the inlet.

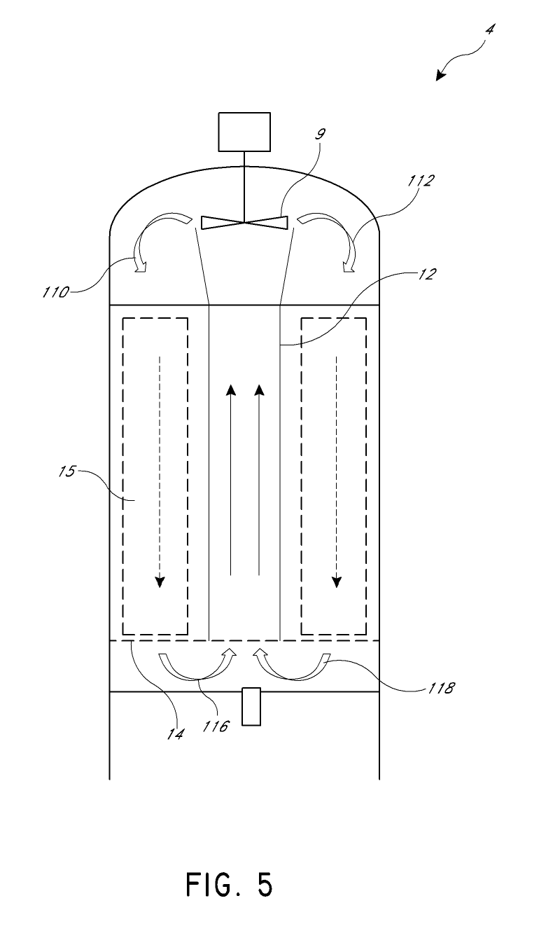

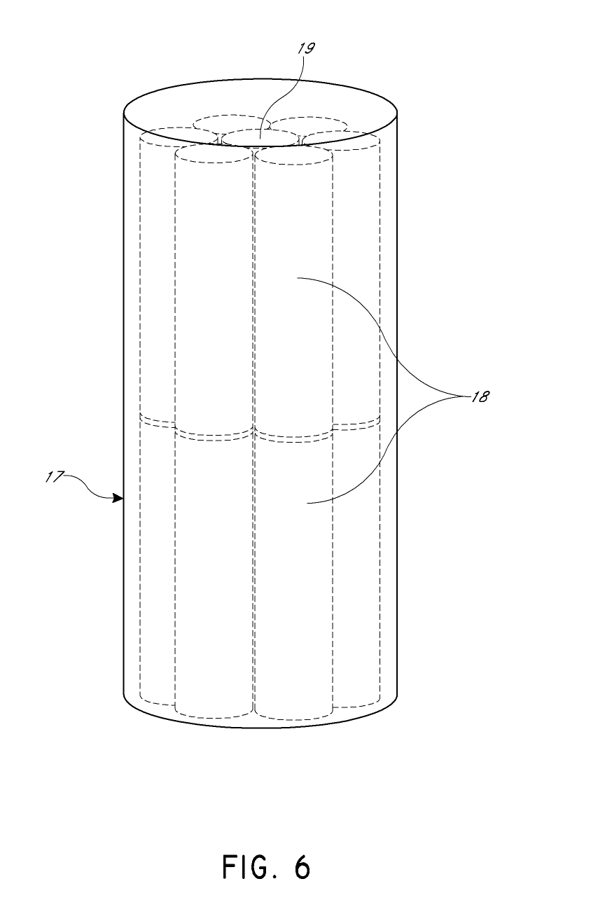

In an alternative embodiment, the membrane elements can also be double (or triple) stacked to fit more membrane area in a single pressure vessel. This alternative embodiment is shown in FIG. 6. The vessel 17 surrounds two stacks of membrane elements 18 which surround a central return flow path tube 19. In this embodiment, the vessel 17 holds twelve membrane elements which is larger than most in-line vessels. The largest common vessel typically will only hold seven membrane elements in-line. In other embodiments, more than two stacks of membrane elements may be possible. In other embodiments, at least twelve membrane elements may be arranged in a stacked configuration. In other embodiments, at least twenty membrane elements may be arranged in a stacked configuration. In other embodiments, at least five, at least 10, or at least 15 total membrane elements may be arranged in a stacked configuration within a pressure vessel.

FIG. 7 shows a plan view cross section of a larger vessel 44 with two concentric arrays of membrane elements 1 around a central return flow path 3. The plate 16 may also restrict the water flow to only down the membrane feed channels. Note that the velocity of the water in each flow section will be determined by the cross section area of the flow path itself. As the cross section of the return flow path 3 is small relative to the sum total of all of the membrane 1 cross sections, one would expect the velocity to be much greater in the return flow path 3. However, the membrane 1 cross sections contain membrane and feed channel spacers while the return flow path 3 is unobstructed. As shown in FIG. 7, the vessel 44 contains 21 membrane elements 1 per level (a two level vessel can hold at least 42, etc.). In other configurations, the pressure vessel 44 may contain at least 7 membrane elements 1 per level, at least 15 elements 1 per level, or at least 20 elements 1 per level. In order to keep the return flow velocity within a suitable range (i.e., not too much faster than the flow through the membranes) the diameter of the return flow path 3 must be approximately one third of the diameter of the entire vessel. Therefore, if these membrane elements were standard eight inch diameter elements (approximately 20 centimeters), the inner diameter of this vessel would be at least 48 inches. If the elements are 18 inches in diameter, the inner diameter of this vessel would be at least 108 inches.

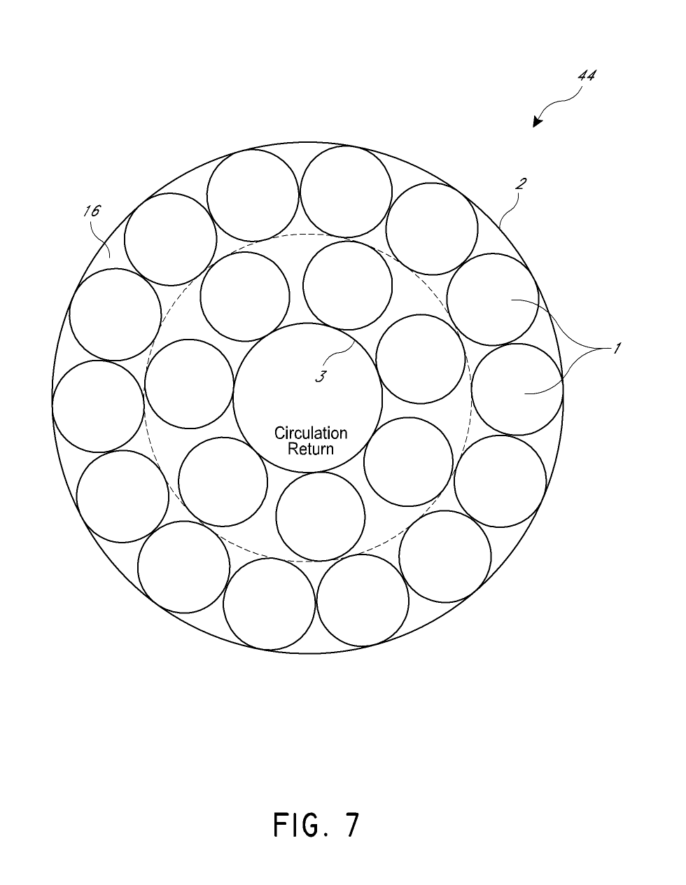

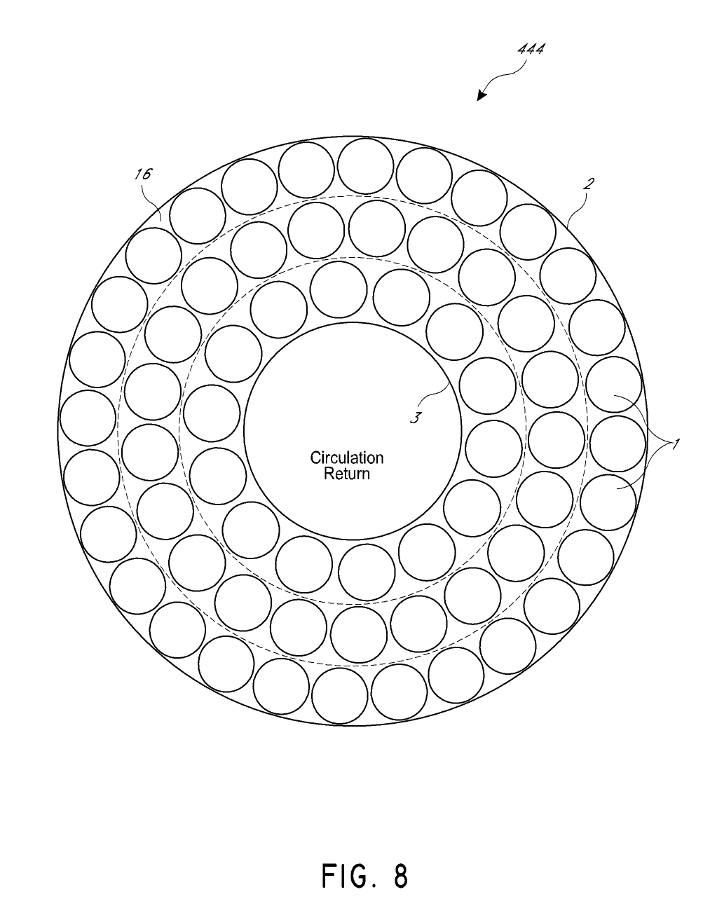

A still larger vessel might contain three concentric arrays of membrane elements. This embodiment is shown in FIG. 8. With three concentric rings the vessel 444 can hold up to 63 membrane elements 1 per level. Given the desire to keep the velocity down in the return flow path 3, one could size the vessel 444 to keep the return path approximately one third of the entire vessel diameter. In some embodiments, the return path diameter is at least one third of the entire vessel diameter, at least one sixth of the entire vessel diameter, or at least one half of the entire vessel diameter. Such a vessel would require an inner diameter of at least 72 inches if the membrane elements were eight inches in diameter and at least 162 inches if 18 inch diameter elements were used. Other diameters of spiral membrane elements are possible but 8 inch and 18 inch diameter membrane elements are shown as examples only. In some embodiments, spiral wound membrane elements may have a diameter of at least 3 inches, at least 5 inches, at least 8 inches, at least 15 inches, at least 18 inches, or at least 20 inches.

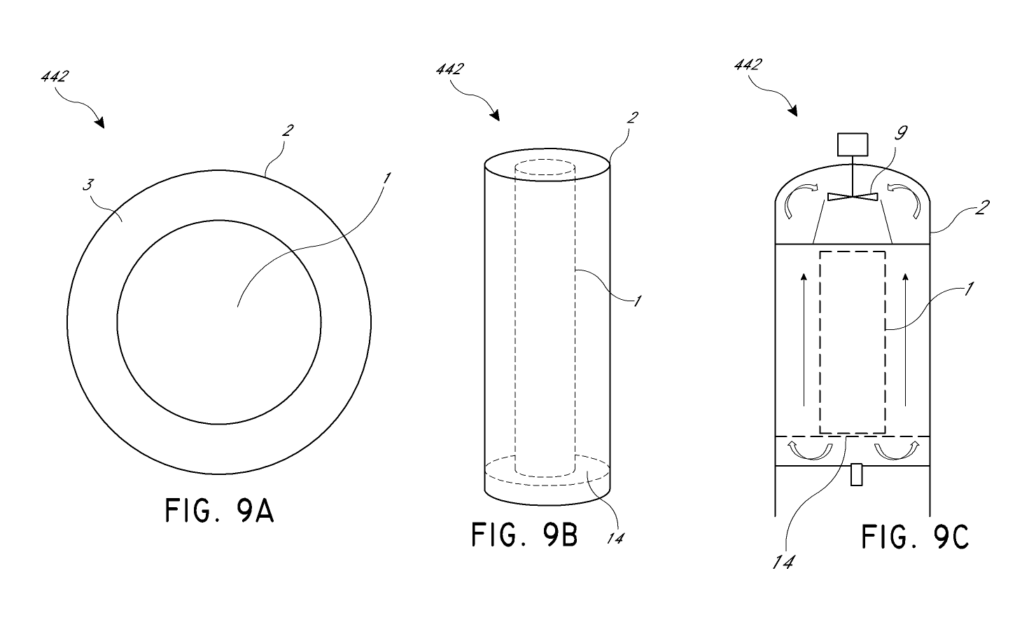

A smaller version of the vessel shown in FIG. 8 containing only a single membrane element is shown in FIGS. 9A, B, and C. FIG. 9A shows the cross section in plan view of this vessel 442 having a membrane element 1, a vessel wall 2 and a return flow path area 3. FIG. 9B shows this same vessel 442 in three dimensions while FIG. 9C shows the flow paths within the vessel 442 with arrows and the supporting wire floor 14. The single element vessel such as that shown in FIGS. 9A-C desirably has a reversed impeller 9 direction. One aspect of the present invention is to move the feed water flow with gravity through the spiral membrane element 1. As shown in FIG. 9C, a central impeller 9 in the vessel will pull the water from the sides and push it down the membrane element 1.

Loading large pressure vessels with many cylindrical membrane elements can be difficult as access to the inside is limited in most pressure vessels. An opening to the vessel sized as large as the entire diameter of the vessel would be prohibitively expensive and unwieldy while a smaller opening does not allow access to the entire vessel. One aspect of the present invention includes a method to input membrane elements at one location within the vessel and place them on a track to enable the membrane elements to move around the vessel. For a very large diameter vessel (i.e., one that is 8 feet in diameter) two openings may be provided: one opening for an operator to stand in that is approximately 25 to 36 inches in diameter, and a second opening into which the membrane elements are to be lowered. The operator standing in the central opening, or in the return circulation path, manipulates the membranes into position and connects the permeate conveyance means.

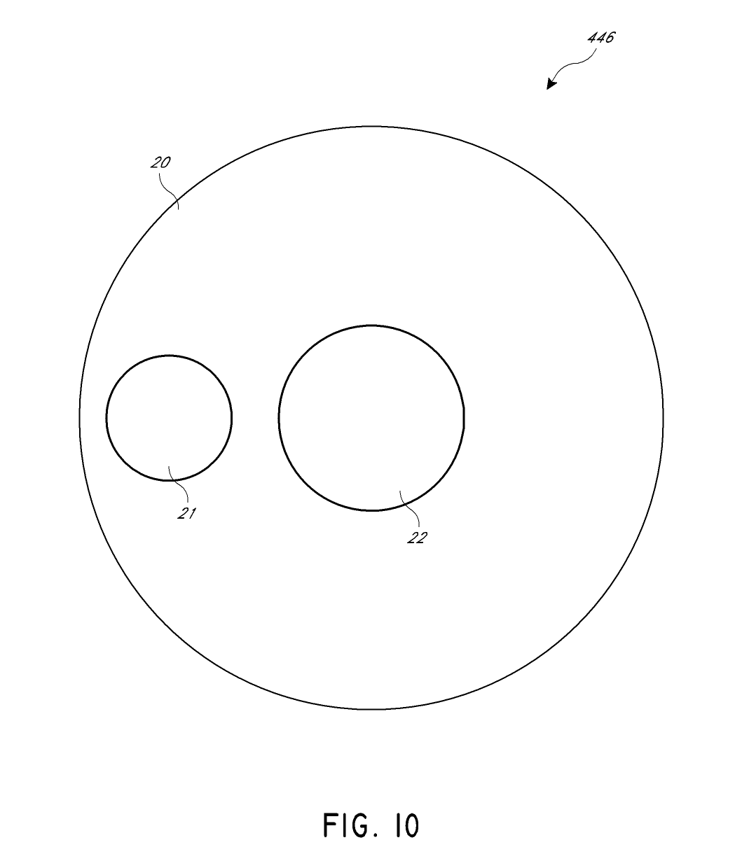

This loading system is shown in the following figures. FIG. 10 illustrates a plan view of the top of a pressure vessel 446 having a vessel wall 20 with two openings 21 and 22. These can be flanged openings where the central opening 22 is large enough for an operator to stand in and receive the elements and connect their permeate pipes. The central opening 22 will also accommodate an impeller that circulates the water around the vessel. As such a large opening is not required for the impeller; a separate flange within the larger flange can be used for the impeller shaft penetration.

In order to load the multiple membrane elements in the pressure vessel without opening a large aperture access point or opening, one embodiment of the present invention provides for tracks on which the membranes can be loaded and then shifted around the vessel. For example, in the vessel 446 shown in FIG. 11, there are three layers of tracks for the three concentric arrays of membranes. The outermost track 23 will contain the most membrane elements as it has the largest circumference. The middle track 24 holds fewer membrane elements than the outer track 23 and the inner most track 25 holds the fewest membrane elements. These tracks allow the membranes to be placed in the vessel through one relatively small aperture or access point 21 and be moved easily to another spot in the vessel. The large central access point 22 is large enough for an operator to stand in and guide the elements 26, 27, 28 around the tracks and into position. FIG. 11 shows one such element 29 that has been loaded in the membrane loading access point 21 before it is moved around the interior of the vessel 446 via one of the tracks 23, 24, or 25 and into its installed position.

Another inventive aspect is a method for holding the membrane elements on the tracks provided in the vessel. The membrane elements can alternatively be arrayed in various other configurations (spiral, planar, curved, corrugated, etc.) which maximize surface exposure and minimize space requirements. The induced vessel pressure forces water through the membrane, and a gathering system collects the treated water and releases it to a location outside of the pressure vessel. Any suitable permeate collection configuration can be employed in the systems of preferred embodiments. For example, one configuration employs a central collector with membrane units or cartridges adjoining the collector from either side. Another configuration employs membrane units in concentric circles with radial collectors moving the potable water to the central collector. Still another configuration employs membrane units extending between collection tubes. In such a configuration, the collection tubes can be configured to support the membrane units, hold them spaced apart from one another, and collect permeate as well.

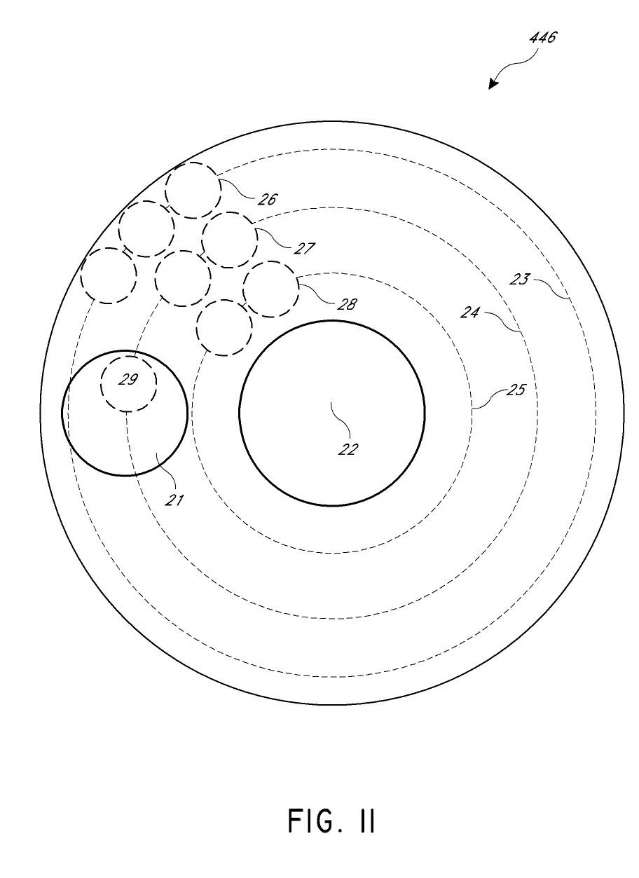

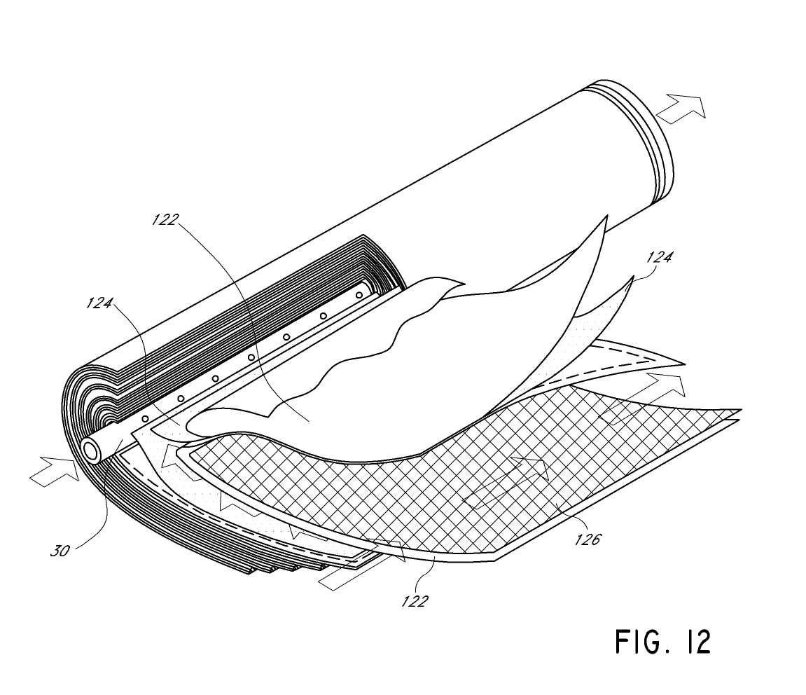

As shown in FIG. 12, a spiral wound membrane element 120 contains a folded membrane 122, a permeate spacer 124, a feed spacer 126 and a central permeate tube 30. This permeate tube 30 allows the permeate to flow out either end. In the present invention preferably permeate is collected at one end. Because of this, one end of the permeate tube 30 may be plugged. One embodiment of the present invention includes a permeate tube plug that also acts as a means for riding on the tracks in the vessel, as shown in FIG. 11. The permeate plug preferably has a sealing means on it to keep the feed water from contaminating the permeate. The sealing means may be a single or a double O-ring on a plug inserted into the permeate tube. FIGS. 13A-C show embodiments of this permeate plug combined with a rail means to move the element around the vessel. In one embodiment shown in FIG. 13A, a plug 130 with a pointed outer end 31 is shown that fits within a female v-shaped track 33. This embodiment shows a double O-ring 32 that fits into the bottom of a permeate tube (not shown) in the vertical membrane element. The track 33 and the sliding mechanism or the plug 130 would maintain a profile so as to avoid blocking the flow of the feed water circulating within the vessel. Therefore the width of the track would desirably be kept as close to the diameter of the permeate tube (or smaller) in order to block as little of the feed water flow as possible.

Another embodiment, the converse of the male plug and female track concept, is shown in FIG. 13B. The plug 135 can be designed with a female adapter 34 which can fit into a male track 36 shown in cross section in FIG. 13B. In this embodiment, a double O-ring 35 is shown. In another embodiment, to enhance lateral stability of the membranes while moving on the track, a forked rail rider can be fashioned. This would allow two points of contact with the rail to avoid tipping in the direction of the track. FIG. 13C shows this embodiment of the permeate plug and rail rider system from the side view of the track. The plug 137 could contain the double O-ring 40 sealing mechanism that is inserted into the permeate tube 38 of the spiral membrane element 37. The forked rail rider end of the plug 137 has multiple tines 39 so that the membrane element 37 does not tip in the direction of the track 41 while being moved around the vessel. The tines 39 of the forked rail rider can be either male or female with the track 41 taking the opposite configuration.

The tracks as depicted in FIGS. 11 and 13 can be structurally attached to the floor near the bottom of the pressure vessel. This structural floor will desirably hold up the membranes while allowing the water in the vessel to circulate, moving from the central return path in the middle of the vessel to the membranes or from the membranes to the central return path. The tracks as depicted in FIGS. 11 and 13 may be separated by the diameter of the spiral wound membrane elements. The tracks may be fixed to accommodate spiral wound membrane elements of a specific diameter or they may be adjustable to accommodate spiral wound membrane elements of various diameters.

Spiral membranes are often comprised of thin film composite (TFC) flat sheet membrane. These can be polyamide reverse osmosis (RO) membranes that are cast onto a support layer often made of polysulfone or other such strong material. As mentioned above, feed water contaminants tend to lodge in the pores of the membranes in membrane-based treatment systems. Contaminant particles also tend to form a coating (which may be several particles deep) on the membrane surfaces, which can block the flow of permeate through the membranes. In reverse osmosis and nanofiltration systems, contaminant particles that are relatively small (e.g., on the order of 1 micron and smaller in diameter) are especially likely to cause this type of membrane fouling. In some embodiments, antifouling particles can be added to the feed water (and/or to the membrane surfaces) to reduce or inhibit fouling of the membranes by contaminant particles.

The antifouling particles that are added to the feed water can be, for example, diatomaceous earth particles, activated carbon particles, or particles of any other material with suitable porosity and/or specific surface area for their intended purpose. The material can be relatively inert, or can be selected to react with particular contaminants, such as industrial contaminants. Additional examples of materials that can be used for antifouling particles in embodiments include clay, bentonite, zeolite, and pearlite. In some embodiments, the antifouling particles can be selected to have a suitable porosity and/or specific surface area and size to attract and adsorb particular contaminant particles, such as, for example, contaminant particles approximately 1 micron in diameter and smaller. For example, in some embodiments, the antifouling particles can have a diameter (or a major dimension) of 0.5 microns or more, 1.0 microns or more, 1.5 microns or more, 2.0 microns or more, or a diameter (or a major dimension) greater than any of these numbers, less than any of these numbers, or within a range defined by any two of these numbers. Also in some embodiments, the antifouling particles can have a specific surface area of 10 m²/g or more, 20 m²/g or more, 30 m²/g or more, 40 m²/g or more, 50 m²/g or more, 60 m²/g or more, 70 m²/g or more, 80 m²/g or more, 90 m²/g or more, 100 m²/g or more, 200 m²/g or more, 300 m²/g or more, 400 m²/g or more, 500 m²/g or more, 1000 m²/g or more, 1500 m²/g or more, or a specific surface area greater than any of these numbers, less than any of these numbers, or within a range defined by any two of these numbers. Alternatively or in addition to antifouling particles having a high porosity and/or surface area, absorbent particles, highly charged particles, magnetic particles, or other particles can be added to feed water as antifouling particles in various embodiments, for example to remove specific contaminants.

In some embodiments, instead of or in addition to supplying antifouling particles to the feed water, antifouling particles (and/or an antifouling material) can be used to form an antifouling layer on the membrane surfaces. In some embodiments, instead of or in addition to supplying antifouling particles to the feed water and/or membrane surfaces, pellets can be added to the feed water to reduce or inhibit fouling of the membranes. The pellets can have any suitable shape, including a cylindrical shape. Other examples of suitable shapes include spherical, nonspherical, elongated, oblong, cubic, cuboid, prismatic, pyramid, conical, or irregular shapes. The pellets can have any suitable size. In some embodiments, the pellets can have a major dimension of about 0.1 mm, about 0.2 mm, about 0.3 mm, about 0.4 mm, about 0.5 mm, about 1.0 mm, about 1.5 mm, about 2.0 mm, or a major dimension greater than any of these numbers, less than any of these numbers, or within a range defined by any of these numbers. In some embodiments, the pellets can have a major dimension less than or equal to about half the distance between the membranes. For example, in an embodiment employing a membrane spacing of about 2.5 mm, the pellets can have a major dimension of, for example, less than or equal to about 1.25 mm. In an embodiment employing a membrane spacing of about 3.2 mm, the pellets can have a major dimension of, for example, less than or equal to about 1.6 mm. The pellets can comprise any material suitable for their intended purpose, such as, for example, plastic, ceramic, or other materials. The pellets can be nonporous or slightly porous, and they can be solid or hollow. The pellets can have any suitable density, including, for example, a density of about 0.9 g/mL, about 1.0 g/mL, about 1.1 g/mL, about 1.2 g/mL, about 1.5 g/mL, or a density greater than any of these numbers, less than any of these numbers, or within a range defined by any two of these numbers.

Anti-fouling particles can be used with these spiral membranes where the anti-fouling particles are high surface area particles such as diatomaceous earth or activated carbon or similar particles. However, when these materials are used in water treatment, they are used as a filter aid and generally deposited on a coarse filter material. This deposited layer of particles acts as a media filter trapping contaminants in the water. The particle size of this media is of little importance when deposited on a coarse substrate, such as sand, and the particles have a broad range of sizes. The particle size does not matter because the water will wash away the very fine particles and they will pass through the coarse substrate, or disposed in a backwash process like in a multi-media filter.

However, when using such anti-fouling particles with TFC membranes, the very fine particles are retained by the tight membrane and can even become lodged in the membrane material itself and clog it. The very fine particles can also make for a less porous coating thereby increasing pressure requirements. For this reason, the present invention entails a method to thoroughly eliminate these fine particles prior to use.

The thorough elimination of these very fine (small) particles can be accomplished by using water to suspend the particles. When the particles are suspended in water, the larger ones will settle to the bottom of the container most quickly. The process, according to one embodiment, entails suspending the particulates in water and letting the larger particles settle to the floor of the container. Then, the water and fine particles (still in suspension) are decanted from the container. The particle settlement rate is well known based on particle size and density. For extra-thorough cleaning of the particulate, multiple washes may be preferred as some fine particles can attach to larger ones and settle. In this case, after the excess water and fine particles are decanted off the top, clean water is introduced again into the vessel and the particulates are re-suspended (for example, the water is stirred). After the requisite settlement time, the excess water is decanted from the top again. Through this process, a particle size distribution can be obtained that eliminates the particles below a certain size based on the settlement time chosen. Any specified particle size threshold may be used. This will allow the particulates to be used with TFC membranes while not embedding into the membrane layer or clogging the passages, allowing the water to pass through the membranes.

In one aspect, the process to produce this washed particulate can be done via batch tanks whereby the particulate is stirred up in a tank of water and allowed to settle (for several hours in most cases). When the larger particulates settle and the smaller ones remain suspended, the water is decanted off the top. The process can be made continuous by utilizing a clarifier or a series of clarifiers. In this case, the water is continuously drawn off the top of the clarifiers and the heavier particulate cake is harvested from the bottom of the clarifier tank(s). The clarifiers can be specially designed to keep a certain particle size in suspension. Filters or screens with a defined opening size may also be used to screen out the target larger particulates. When the screens/filters are washed, particulates can be captured.

To further speed up the process of washing the fine particles from the particulate material, a hydrocyclone may be used. In this case, the larger particles move to the outside of the hydrocyclone via centrifugal force rather than to the bottom of a container via gravity. The operations of a hydrocyclone are well known and will allow much faster production of the washed particulate.

Another aspect of the present invention includes the use of these anti-fouling particles in a wet state. The fine particles that are washed away in this process can be reintroduced when the particles dry out via cracking and breaking. As the particles dry, the loss of moisture can cause them to become brittle and break. This breakage can reintroduce small particles which can block flow to the membranes. In traditional water treatment filtration media, the smaller particles will be washed away in the treatment as the substrate holding the media has large pores. However, in membrane filtration, as in the present invention, the substrate for the anti-fouling particles is a tight, sometimes even osmotic, membrane. Such a tight membrane will not allow the small particles to pass and they will accumulate and block the passage of water through the membrane. One aspect of the present invention entails washing the particulate to eliminate the small particles below approximately 0.5 microns in diameter and also not allowing the particulate to dry before use. The screening size for the minimum particle diameter will be determined by the membrane type and the feed water constituents.

Shipping the wet particulate to customers will entail greater shipping costs due to the additional water weight. However, larger installations can install washing equipment on site and purchase raw and dry anti-fouling particles (such as diatomaceous earth or activated carbon) from a supplier and avoid the additional cost of shipping wet anti-fouling particles.

FIGS. 14A and B illustrate this washing process. First, the anti-fouling particles are stirred into a vessel 42 of water so that they are in suspension as represented by the shaded liquid 43 in FIG. 14A. The particles are allowed to settle via gravity for the requisite settlement time (which can be several hours). Settlement time is determined by, among other things, the desired particle size and the density of the particles. Then, the remaining water with the small particles still in suspension (represented by 44 in FIG. 14B) is decanted off the top while the settled particles 45 have formed a cake on the bottom of the vessel 42. The settled particles 45 are then packaged to retain some water until use so that the particles 45 do not dry and crack, thus negating the process by creating more small particles.

Embodiments of the system can be operated by providing pressurized feed water to the vessel containing the membranes. The differential between the feed water pressure and the relatively lower pressure on the permeate side of the membrane starts the filtration process. The following parameters can be adjusted depending on the treatment goals and the feed water quality:

Membrane type: Different membrane types can be used achieve different treatment goals. Tighter membranes are generally capable of removing more contaminants, but require higher pressures and tend to operate at lower fluxes (output per area). If using the system to pretreat water prior to a subsequent treatment step, certain membranes such as nanofiltration can be used to minimize maintenance on the second treatment step.

Re-circulation rate: The rate at which water is circulated in the vessel will affect the cross-flow velocity of feed water at the surface of the membrane. Increased cross-flow velocity promotes mixing of particulates and dissolved contaminants within the raw water and prevents settling and fouling of the membrane surface.

Feed water pressure: Feed water pressure is generally a function of the type of membrane used, the osmotic potential of the feed water, the desired flux (output per area of membrane), and the longitudinal headloss produced from the re-circulation.

Recovery rate: This is defined as the percent of feed water recovered as permeate (1—concentrate %) versus the total amount of feed water used (example: 50% recovery is 2 liters of feed water producing 1 liter or permeate).

Vibration regime: Vibratory cleaning provides a real-time method of removing particles from the membrane surface while the system is in use. For a given water quality there are several parameters within the vibration regime (e.g., frequency, intermittency, energy, location of input) that may be adjusted to, for example, improve membrane cleaning and/or reduce power consumption of the system.

In embodiments of the invention, these and other system and operational parameters can be adjusted based on source water quality, and source water availability, and treatment goals. These parameters can be adjusted so that the same system can be used for a broad range of source water qualities and treatment goals. In some applications, these parameters can be adjusted as source water quality changes (for example due to seasonal changes or environmental occurrences). Embodiments thus offer a significant advantage over conventional systems, which lack such adaptability to variance in feed water quality, and which therefore require complex and expensive pretreatment systems in order to achieve a consistent feed water quality. Embodiments can be operated at recoveries of anywhere from 20% or lower to recoveries of 80% or higher, depending on source water quality, maintenance preferences, and other considerations. In one embodiment, NF membranes can be used with a flux of 5 to 10 gfd, a recovery of 50-60%, and a recycle rate of about 15 times. The re-circulation and vibration regime of embodiments can be used to provide a highly cost effective maintenance program, in which the energy consumed by vibration and re-circulation is more than offset by the savings resulting from the reduced maintenance requirements, the relative absence of moving parts, and the absence of conventional low pressure membrane cleaning like backwashing or air scouring.

Embodiments of the system can be operated in a single-stage process in which the feed water enters a vessel and interacts with the membranes in that vessel until the feed water reaches a concentration corresponding to the desired recovery rate, at which point the concentrate can be evacuated from the vessel and disposed of (for example, returned to the external environment, or to a sewage treatment plant, in the case of a water reuse application). In some embodiments, concentrated feed water can be evacuated from the vessel continuously, through an aperture of any suitable size at a rate that when added to the permeate production rate equals the raw water inflow rate. In other embodiments, concentrated feed water can be evacuated from the vessel in a pulsed-release process, in which a relatively larger volume of concentrate is released intermittently through a relatively larger aperture, so as to obtain the same time-averaged rate of release as a continuous process while increasing the amount of solids disposed with the concentrate.

When high surface area particles are used to coat an osmotic membrane a no-brine water softener can be created. Hardness is comprised of the polyvalent ions in the water such as calcium and magnesium. Certain osmotic membranes can reject large amounts of these ions. The membranes that selectively reject these polyvalent ions without rejecting large amounts of monovalent ions, like sodium (Na) and chloride (Cl), are often called nanofiltration membranes (NF). As with all osmotic membranes the NF membrane traditionally produces a concentrate stream to dispose of the rejected dissolved solids. The present invention uses NF membranes to reject the hardness to a point of saturation in the concentrate. At the point of saturation the dissolved hardness will precipitate out of solution and become suspended solids. For example, the calcium will concentrate in the membrane system as soft water passes through the membrane. It will eventually become saturated and will precipitate out of solution in the form of, say, calcium carbonate or calcium phosphate or some other solid. As these suspended solids are relatively large they can easily be screened out of the concentrate with a simple hydrocyclone or cartridge filter. If a cartridge filter is used it will become clogged with the suspended calcium-based particles and then the filter is simply discarded or cleaned. A hydrocyclone will desirably remove the solids continuously without consuming filters. This process avoids liquid discharge since the concentrate has the precipitate removed and is introduced back to the front of the process again. The precipitated solids are removed and discarded as solid waste.

In a preferred embodiment, this process can be broken into two steps to save cost and footprint. As different water sources have different levels of hardness and different treatment goals, this process can be made more efficient by softening the water in a traditional membrane to a point just below saturation. Then the concentrate can be introduced into the more open format membrane element with the high surface area anti-fouling particles. As the more open membrane elements and the anti-fouling particles represent a slightly more expensive process, using them for only the final concentration step is advantageous. The level of saturation will depend on the source water but other embodiments may include a process whereby the first membrane step (NF) will concentrate the brine by removing 80% of the water and rejecting nearly all of the hardness. The resulting 20% of the water that is near saturation will be introduced into an open configuration membrane element that can be coated with anti-fouling particles. As these membranes remove more soft water from the feed water the calcium will begin to precipitate out of solution. As it does, the suspended particles will find surface area onto which to precipitate. The coated membrane will offer the surface area of the coating particles (and any injected particles) for this precipitation to occur. A downstream hydrocyclone or cartridge filter will screen out the suspended precipitate and the anti-fouling particles.

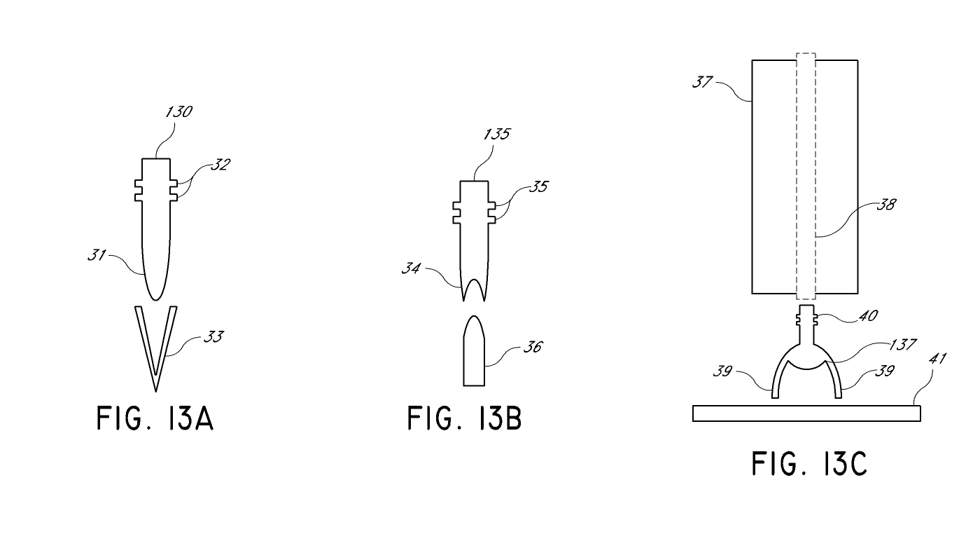

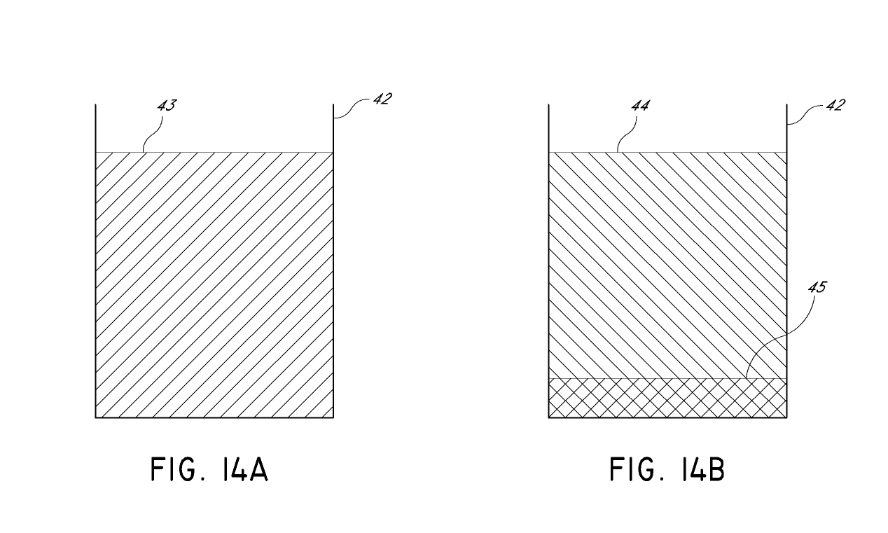

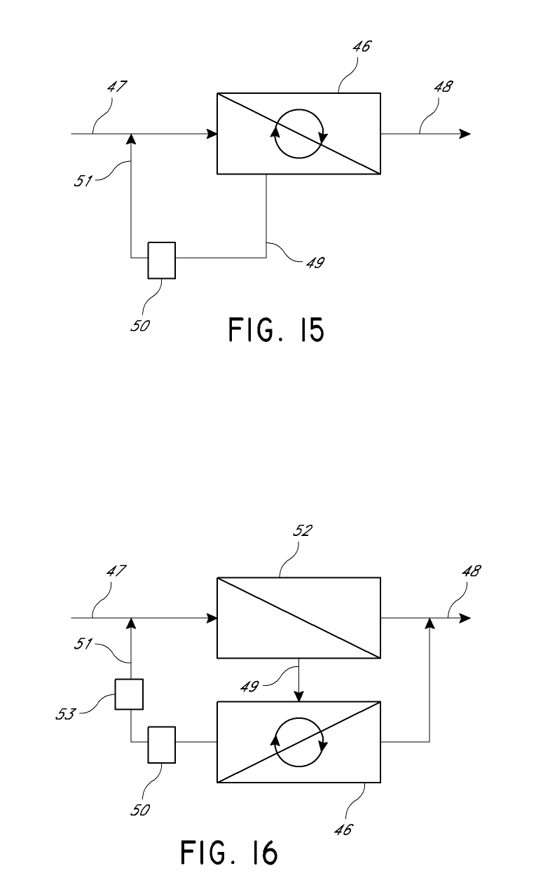

The above-described process is illustrated in FIG. 15. The influent 47 is introduced into an open configuration NF membrane vessel 46 and the separation results in two streams: a permeate 48 of reduced hardness and a concentrate 49 of increased hardness. This process can be run in order to induce precipitation of the dissolved hardness in the water; that is by increasing the recovery rate of the membrane stage. The concentrate can reach the point of precipitation where the hardness falls out of solution and onto the anti-fouling particles. In order to reach the point of precipitation the recovery rate (the ratio of permeate 48 flow to influent flow 47) must be high enough for the hardness ions to reach saturation. The concentration level of saturation is dependent on many factors (temperature, makeup of total dissolved solids, pH, etc.). The hardness in the influent 47 is not a suspended solid but a dissolved solid; therefore it cannot be screened out by a hydrocyclone 50 (or cartridge filter). However, after precipitation onto the anti-fouling particles, the hardness can be filtered out with a hydrocyclone 50 (or cartridge filter). The effluent 51 from the hydrocyclone 50 (or cartridge filter) can then be introduced to the influent stream 47 to capture 100% of the liquid in the process (a booster pump (not shown) may be required as the filtrate will be at lower pressure than the influent). The open configuration NF membrane process discussed above can be any NF membrane process whereby the feed channel is open enough to handle high suspended solids loads. A tubular membrane is an example of this. Certain membrane companies have introduced spiral thin-film composite membrane elements with feed channels specifically designed to handle large solids loads.

In another embodiment, a more efficient two-step process can be seen in FIG. 16. In this case the influent 47 is introduced into a more traditional NF membrane vessel 52 and the recovery rate is set such that the concentrate 49 from that process does not quite reach saturation. As the traditional NF membrane 52 (a spiral membrane) cannot handle the precipitated solids, care must be taken to keep this stage below saturation level of concentration. Then the concentrate 49 from the traditional NF membrane vessel 52 is introduced into an open configuration membrane vessel 46. The concentrate is introduced to a hydrocyclone 50 (or cartridge filter) to remove the suspended precipitate and other particulate. This process may be aided through the adjustment of pH, which will accelerate the precipitation. The effluent 51 from the hydrocyclone (or cartridge filter) is re-introduced into the original influent stream 47 and it may have to be re-pressurized with a booster pump 53 in order to make up for the lost pressure from the two membrane stages 52, 46 and the hydrocyclone 50 stage. The permeate from both of these membrane steps are combined as the final process effluent 48. This process is more efficient than that shown in FIG. 15 because the traditional NF stage 52 is far more space efficient than the open membrane element that can handle the high suspended solids load.

Permeate collection pipes inside the pressure vessel may require pipes that must withstand the pressure of the vessel as the permeate is at low pressure on the inside of the pipes while high pressure on the outside creates the treatment differential. With multiple membrane elements within the vessel a manifold and collector system desirably is employed. Each manifold can collect the permeate at the top of the element and feed the permeate into a loop pipe at the top of the pressure vessel. As the larger diameter vessels will have multiple concentric arrays of membrane elements, manifolds can collect the permeate of several radial membrane elements and move it to the collection loop at the top of the vessel.

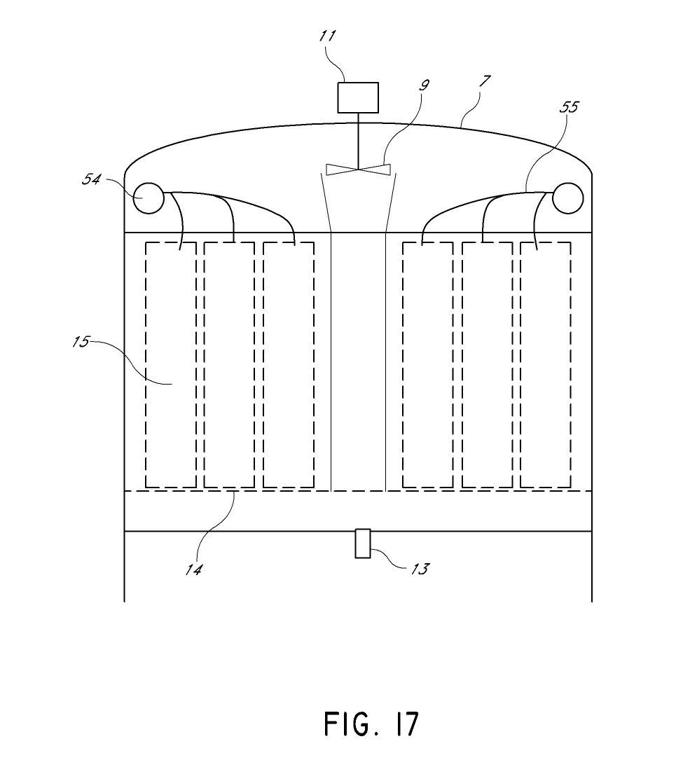

One embodiment of collection pipe and manifolds installed within a pressure vessel can be seen in FIG. 17. A flexible collection manifold 55 can be made of pressure resistant (i.e., higher pressure outside the conduit than inside) hose. It can collect permeate from at least one element 15 in each ring and convey the permeate to the collection pipe 54 that circles the entire vessel. Some of the other components from FIGS. 4 and 5 such as the membrane elements 15, the drain valve 13, and the impeller motor 11 are also shown in FIG. 17. As shown, the vessel 7 contains three rings of membrane elements 15 around a central collector flow path with an internal impeller 9 driven by an external motor 11, similar to the membrane element arrangement shown in FIG. 8.

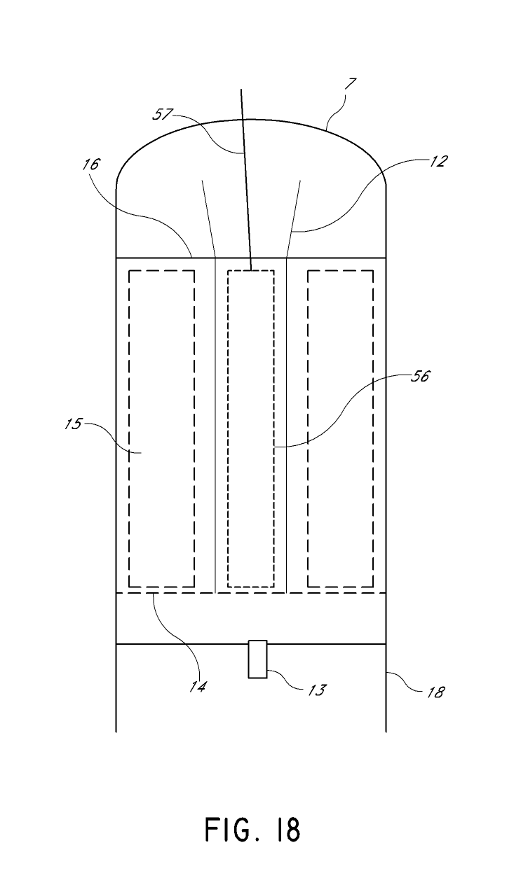

Another embodiment of the present invention entails utilizing a submersible pump in place of the impeller. FIG. 18 shows this embodiment with the analog to FIG. 4. In FIG. 18, a submersible pump 56 is used instead of the impeller and external motor configuration shown in FIG. 4. In the embodiment shown in FIG. 18, the driving mechanism is enclosed within the pressure vessel 7. Instead of a shaft transferring the work to the impeller, a wire 57 penetrates the vessel 7 to bring power to the submersible pump 56. The pump 56 will require low head pressure but high flow volume. In the pressure vessel 7 shown in FIG. 18, the flow direction causes the feed water to circulate up through the submersible pump 56 and down the membrane elements 15. When the water exits the bottom of the elements 15 it goes through the mesh floor 14 and back to the submersible pump 56. The vessel 7 is also shown with a drain valve 13 at the bottom to periodically release any collected solids that might settle.

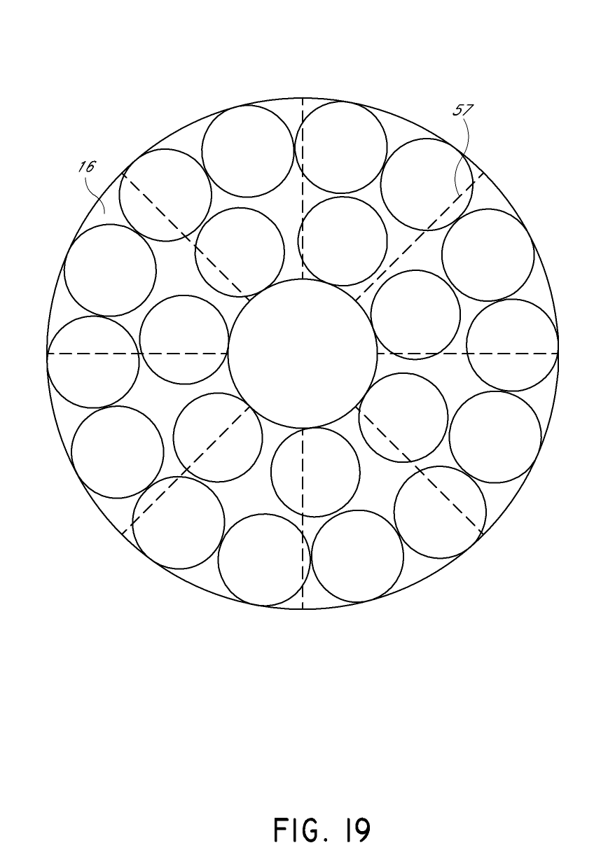

In some embodiments, the flow restricting plate 16 shown in FIG. 7 can be subdivided into smaller segments in order to insert it in to the interior of the vessel through an opening smaller than the entire vessel diameter. FIG. 19 illustrates this subdivision. The flow restricting plate 16 may be divided into smaller sections so that it can be introduced into the pressure vessel through a smaller aperture. The dividing sections are shown with a dashed line 57 in FIG. 19. This plate 16 can seal to the membrane elements to direct the flow through the membrane elements.

### Feed Spacer

Membranes used in water treatment and for other industrial purposes are often configured in spiral wound elements. The spiral membrane element is an efficient means to get a high surface area of membrane into a cylindrical pressure vessel, though this efficiency (i.e., high packing density) also results in a propensity for the membrane to foul. Membrane fouling occurs when the contaminants in the water (or solution to be treated) block the water from getting through the membrane. Fouling can limit the flow through the membrane surface (flow perpendicular to the membrane face) or it can limit the flow through the membrane element (flow parallel to the membrane face). The longitudinal movement of the water through the membrane element is limited by particulate fouling resulting in either the need for frequent and expensive chemical cleaning or expensive pre-treatment of the feed water to remove suspended material. The construction of the spiral wound membrane element to mitigate this particulate fouling is the focus of some aspects of the present invention.

The spiral membrane element is comprised of flat sheet membrane leaves around a central perforated permeate tube. The leaves are comprised of two back-to-back sheets of membrane sealed around a permeate spacer or carrier sheet. Those skilled in the art are well aware of the construction of the spiral wound membrane element.

The leaves of a spiral element are arrayed in a radial fashion from the central permeate tube before being wound. In order that the membrane leaves do not touch each other when wound up, a spacer sheet is laid between each adjacent membrane leaf. The spacer sheet provides a consistent space between each membrane face for the feed water to flow. The thickness of this sheet is related to two things: 1) the feed water clarity; and 2) the interval between cleaning the membranes. The spacer sheet is traditionally made of polyester (or other plastic) woven netting.

The suspended solids in a feed solution determine how clear the water is. Suspended solids are a major cause of membrane fouling. Suspended solids will settle when the feed water velocity is low. The traditional feed spacer sheet is commonly a plastic mesh that can block the flow of the water and create local dead spots where water is stagnant or very slow moving. It is in these spaces that suspended solids will settle, aggregate, and ‘foul’ a membrane element. The more clear the water, or void of suspended solids, the less likely the membrane will foul. Thus, the amount of suspended solids or the clarity of the water will determine the maintenance interval for membrane cleaning. However, the construction of the membrane element itself can also determine the aggregation of suspended solids on the membrane surface. One aspect of the present invention is concerned with the construction of the feed spacer sheet to mitigate this membrane fouling.

A traditional spiral wound membrane element has a feed spacer mesh comprised of thin plastic strands woven in two directions, generally perpendicular. These two sets of parallel strands have a thickness dimension when woven which determines packing density (area of membrane contained per unit of pressure vessel volume) and also the preponderance of membrane fouling. Generally, the greater the thickness dimension of the parallel strands the longer the duration between membrane cleanings. These parallel mesh filaments create a diamond shape feed channel spacer sheet. The strands are set in parallel within each plane, and form an angle with the strands in the other plane. Particulate matter which enters the spiral wound element typically accumulates where the strands are in close contact with the membrane surface. Deposits of solids are typically seen on both sides of the strand, the upstream side and the downstream side (leeward side). Due to fluid dynamics, a shadow or “dead zone” on the downstream side of the strand may form such that there is no force to remove solids which have been deposited there.

The more open the feed spacer sheet is, the less opportunity there is for particulate settlement and therefore less opportunity for membrane fouling. One aspect of the present invention is a novel spiral membrane construction with a feed spacer mechanism that is particularly well suited to spiral membrane elements that are vertically oriented. In particular, the invention is intended to optimize spiral membrane elements oriented in a vertical fashion, though in some embodiments the membrane elements can also be used in a horizontal orientation.

Spiral wound membrane elements are often mounted in a horizontal pressure vessel. This orientation means that the membrane leaves that are oriented in a radial fashion from the central permeate tube are laying on each other and gravity would otherwise have the membrane leaves touching, therefore rendering the area of membrane touching another area of membrane useless. Spiral elements are periodically oriented vertically, though the horizontal orientation is far more prevalent. Membrane manufacturers engineer the membranes for both orientations but the horizontal orientation is the limiting factor with respect to the feed spacer because gravity will force the membrane leaves to sit on each other. Conversely, when the spiral elements are oriented vertically, gravity does not force the membrane leaves to touch. While a consistent spacing between the leaves still requires a spacer of some sort, the lack of gravity as a major attractive factor means the feed spacer can be designed differently, or far more openly, for a vertical membrane element orientation. The more open architecture can greatly mitigate membrane fouling.

In a preferred embodiment of the present invention the feed spacer is comprised of parallel bars oriented in the direction of the feed flow (vertically) creating channels without obstruction or low velocity spots where particles can settle. These parallel bars can either be cylindrical or oval or have an I-beam like cross section or the bars may be any other shape that would provide parallel channels through the membrane element. These parallel bars can be joined by cross members, or filaments, in order to create sheets for ease of manufacturing. These cross members do not need to touch the membrane leaves on either side of the channel as they are not required for structural support of the membranes as the vertical orientation creates gravitational force on the longitudinal length of the membrane rather than on the face of the sheets. Similarly, the spacing between the parallel bars can be greater in a vertically oriented membrane as compared to a horizontally oriented membrane element because of the lack of gravity forcing the membranes to touch.

Another embodiment of the present invention is a feed spacer sheet with large voids cut out to create more open area, thus mitigating fouling in those areas. Since in the vertical orientation of the spiral membrane element the force of gravity does not provide an attractive force for adjacent membrane leaves, the feed spacer sheet does not need to cover the entire membrane leaf. That is, the spacer is merely required to maintain space between the membrane leaves counteracting non-gravity attractive forces between the leaves, particularly on the leading and trailing edges of the element. In the horizontal membrane orientation, the additional force of gravity attracting the leaves requires a more continuous spacer with less open space, thus creating more fouling. In the vertical orientation of the membrane element, the feed spacer sheet can be minimized by cutting large voids from the sheet, maintaining the integrity of a continuous sheet for ease of element construction while creating vast open areas to mitigate fouling. These cut out voids can be positioned such that the leading and trailing edges of the element are covered in spacer material in order to maintain structural integrity.

It is well known that the preponderance of membrane fouling or particle settlement occurs where the feed spacer touches the membrane face. If there is less feed spacer material touching the membrane face, there will be less fouling. As strips of feed spacer material can be positioned to reduce the area covered, this will require more complex manufacturing techniques. However, if a continuous feed spacer sheet has large voids cut out, it can still be handled as a single sheet and integrated into the spiral wound membrane element.

In constructing the membrane element, feed spacer sheets are cut approximately to the size of the membrane leaves. These sheets can then be stamped with a die or equivalent cutting device to remove large portions of the feed spacer sheet. This process is analogous to punching out window panes in the sheet while leaving the cross braces of feed spacer material in a grid. While this method might lead to spacing problems in a horizontally oriented membrane element, it can greatly reduce fouling in vertically oriented ones.

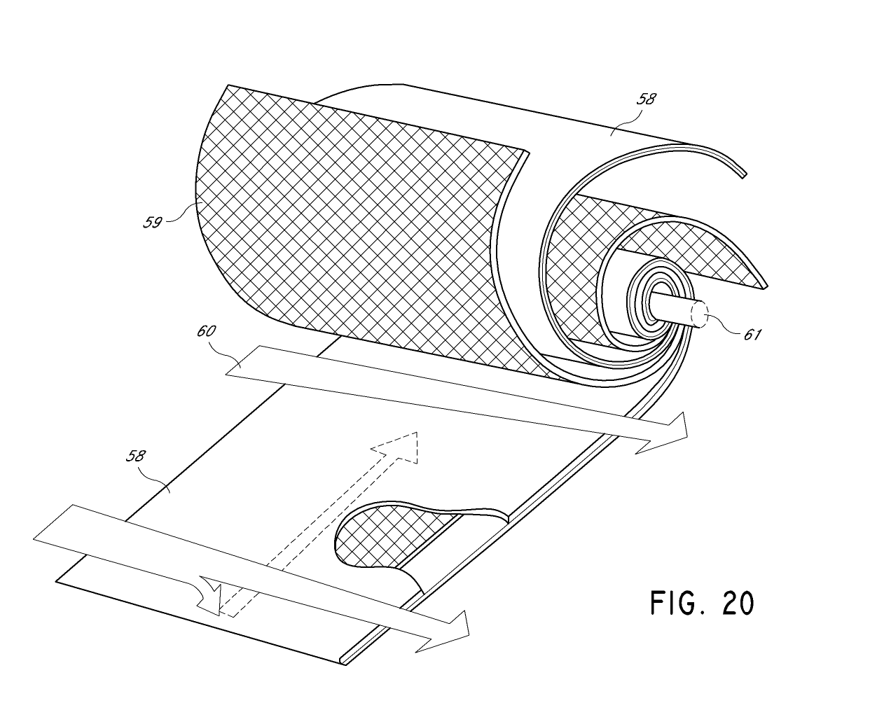

FIG. 20 shows a traditional spiral wound membrane element and how it is constructed. Leaves of membrane 58 are connected to a perforated permeate collection tube 61. A feed spacer sheet 59 is disposed between each membrane leaf 58 to keep them separated from one another. The flow of the feed water is in the direction 60 parallel to the permeate collection tube 61.

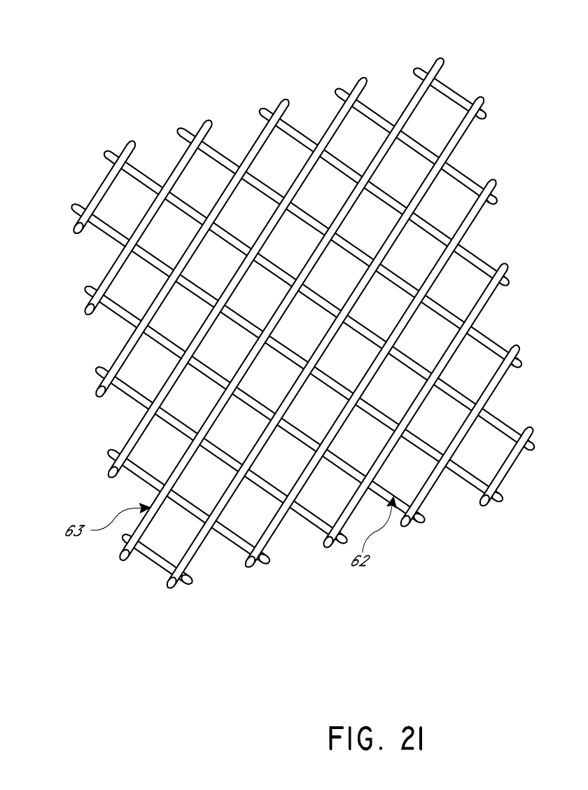

FIG. 21 shows a common feed spacer web design. This web is comprised of two sets of parallel filaments woven together. The first set of filaments 62 is disposed at an angle from the second set of parallel filaments 63. The angle can vary but it is typically from about 60 to about 90 degrees.

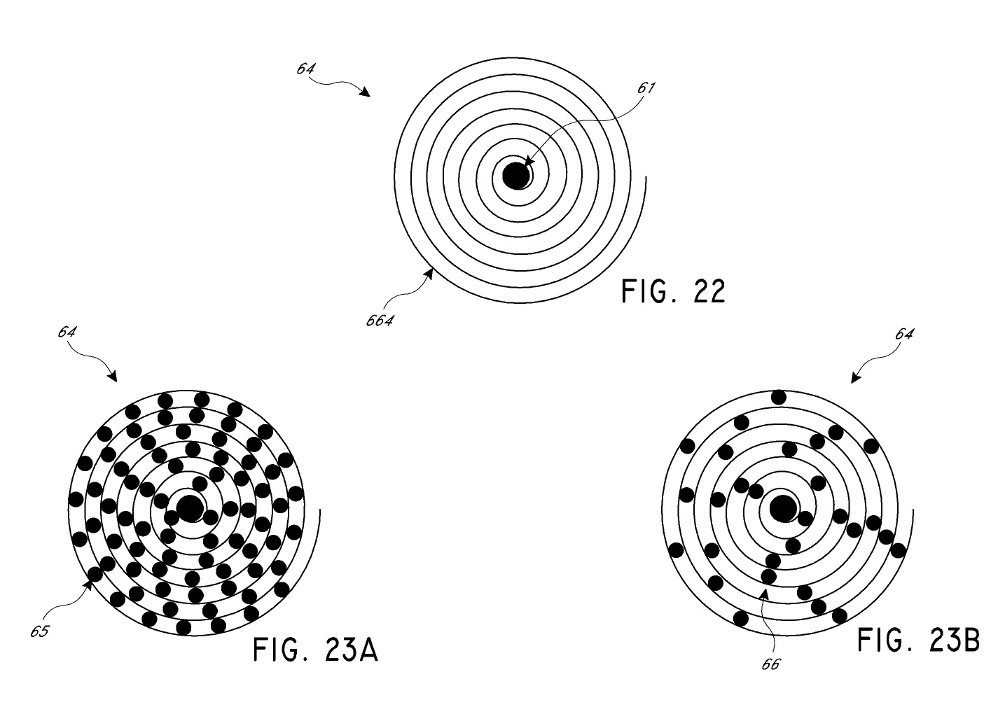

FIG. 22 shows the cross section of a spiral wound membrane element 64 with a single membrane leaf 664 attached to a permeate collector tube 61. The single leaf 664 in this figure lacks a feed spacer disposed to separate the membrane leaf (multiple leaves are more common, but for sake of explanation a single leaf is shown). It can be seen that without a spacer of some sort, the thin film membrane pocket would attract to itself when it overlaps, regardless of the orientation of the membrane element.

FIGS. 23A and B show the same spiral wound membrane element 64 as in FIG. 22 but with spacer elements 65 disposed in the spaces created by the spiral. These spacer elements 65 are shown as round cross sections implying cylindrical shaped spacers running the length of the element parallel to the direction of the feed flow. FIG. 23A shows a tight spacing of these spacer elements 65 which might be required if the element 64 were oriented horizontally. The span between spacer elements 65 is small so that the bridge can withstand the force of gravity weighing on the membrane leaf. When the element 64 is oriented vertically, however, the span can be much greater as shown in FIG. 23B. An unsupported space 66 which, in the horizontal orientation, might collapse and touch the adjacent layer can, in the vertical orientation, can maintain separation. There is a reduced need for separator material in the vertical orientation.

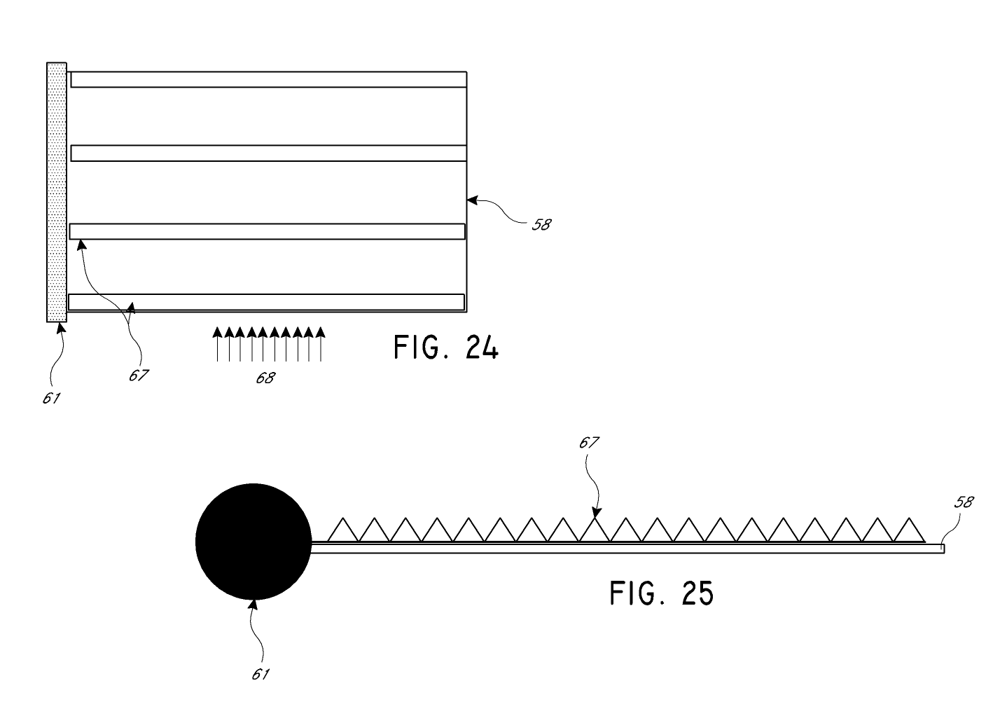

FIG. 24 shows a single membrane leaf 58 connected to a perforated permeate collection tube 61 prior to being wound. The feed water flow direction 68 is parallel to the permeate collection tube 61. In one embodiment of the invention, strips of corrugated material 67 can be disposed at intervals along the membrane leaf 58. The corrugated material 67 will maintain the separation between the membrane layers where it is disposed and bridge the areas where it is not. FIG. 25 shows a cross section of the single membrane leaf 58 attached to a perforated permeate collection tube 61 with the corrugated spacer strip 67. The corrugated spacer strip 67 is shown with a traditional corrugation back and forth fold, but other corrugation means would suffice.

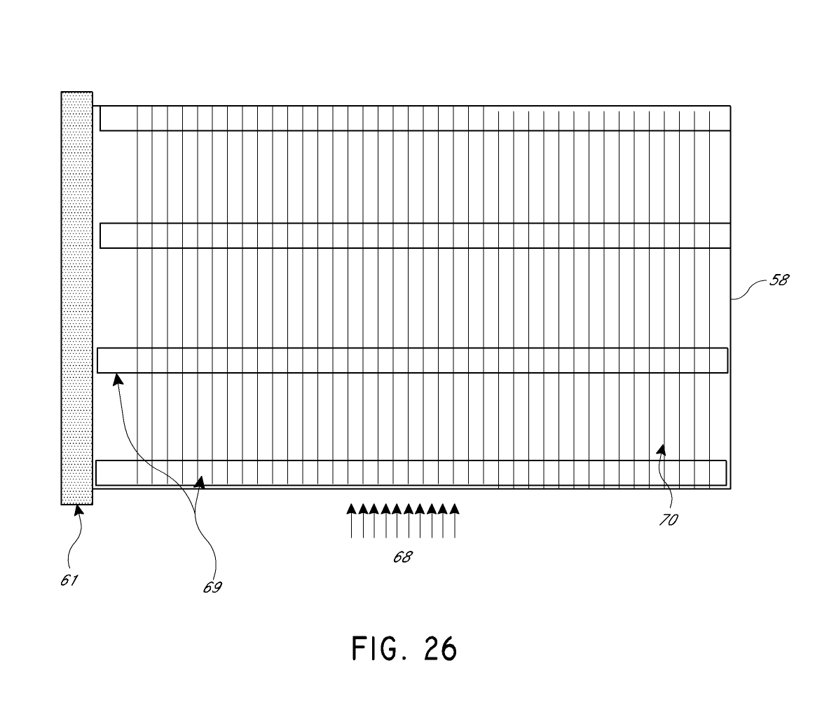

With the strips of corrugated material as shown in FIG. 24 the element might lack structural integrity in the direction of the feed water flow 68. Structural integrity of the element in the direction of the feed water flow 68 can be aided by orienting spacer members in that direction. FIG. 26 shows a series of thin parallel rods 70 oriented in the direction of the feed water flow 68, which is parallel to the permeate collection tube 61. In this embodiment cross strips 69 are disposed periodically to connect the spacer rods 70. In this case the strips 69 do not need to be corrugated as the corrugation in FIGS. 24 and 25 is designed to maintain separation whereas the rods 70 themselves provide that function in the embodiment shown in FIG. 26.

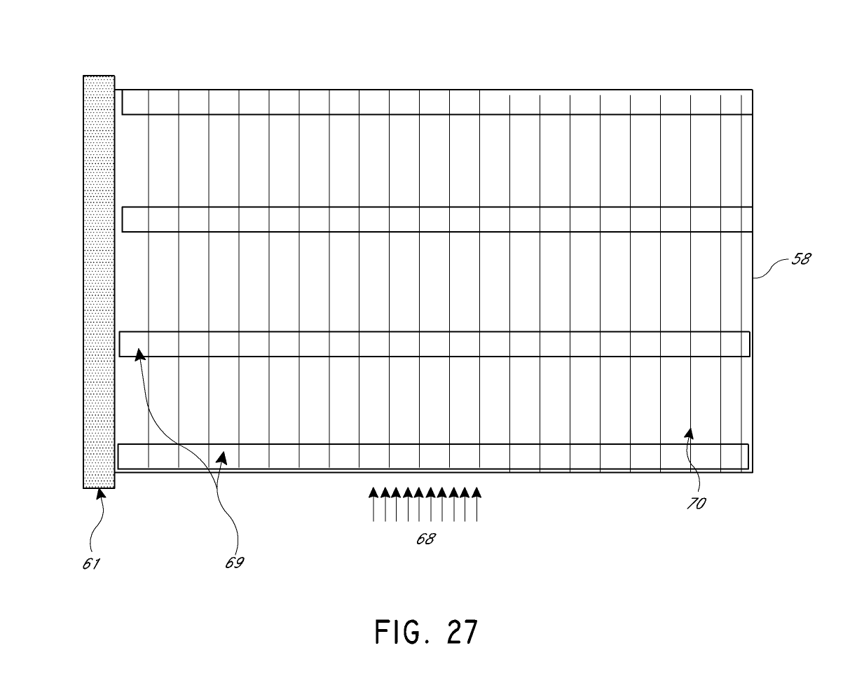

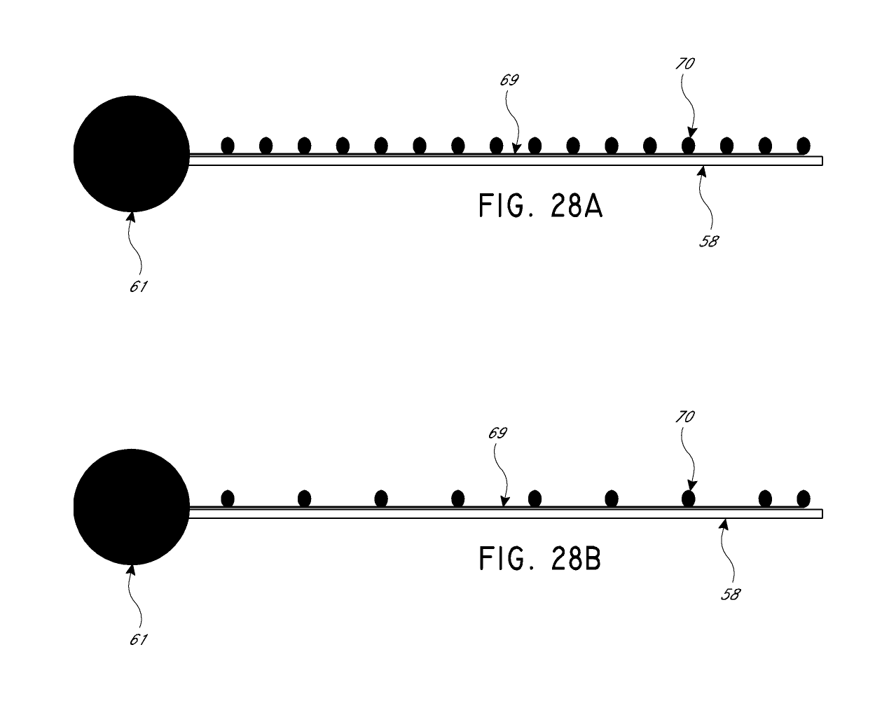

FIG. 27 shows a similar embodiment of a membrane leaf 58 as that shown in FIG. 26 but with fewer parallel rods 70. If the membrane element is disposed in the vertical rather than the horizontal, the spacer rods 70 can be further apart (that is, fewer of them for the same amount of membrane area) as the lack of gravity forcing the membranes together allows for a greater separation between the spacer rods 70. FIGS. 28A and B show the cross sections of the single membrane leaves 58 shown in FIGS. 26 and 27.

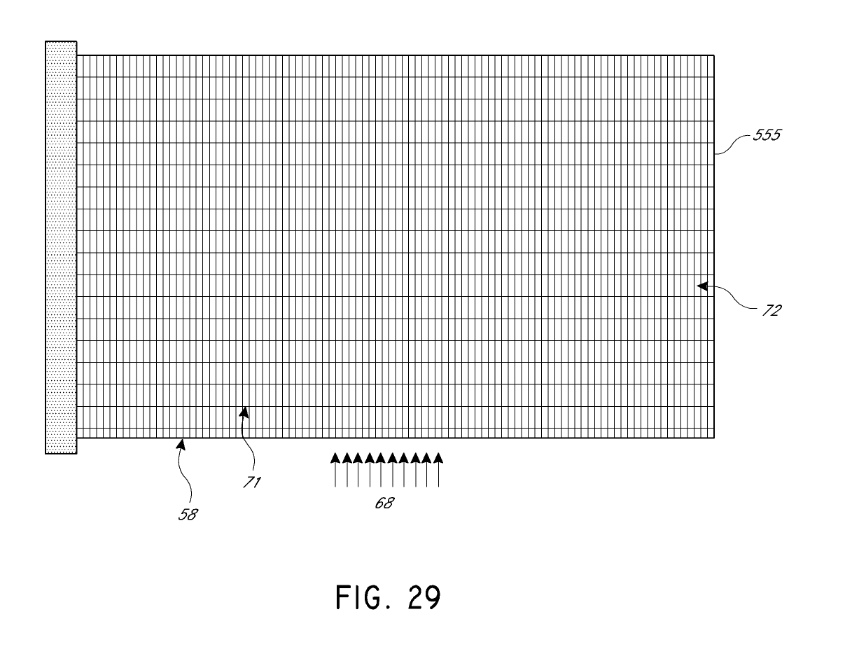

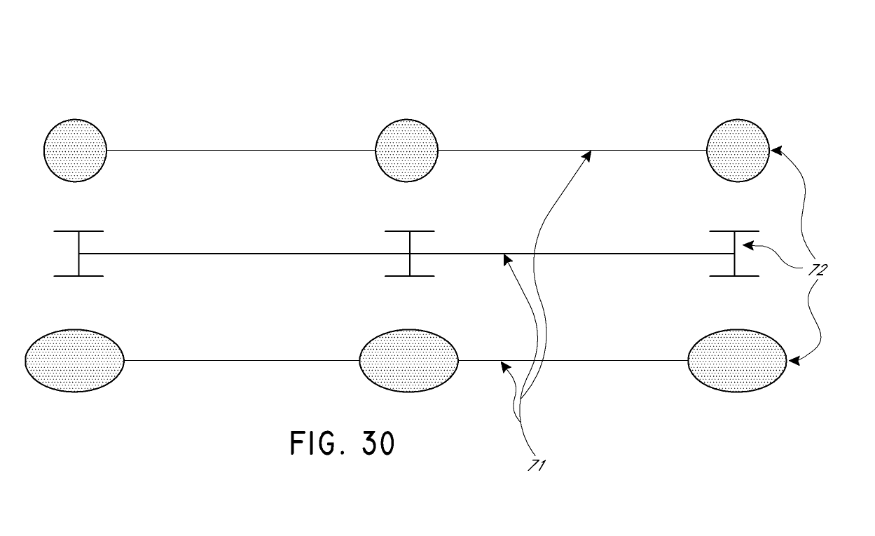

A preferred feed spacer sheet 555 is shown in FIG. 29. Parallel rods 72 in the direction of the feed water flow 68 are connected by approximately perpendicular filaments 71. The parallel channels created by the rods 72 allow for an open configuration and good cross flow of the feed water. The perpendicular filaments 71 connect the rods 72 for ease of manufacturing. FIG. 30 shows that the rods 72 can have many cross sectional shapes (shown are round, oval, and I-beam) that would maintain separation between membrane leaves 58. The perpendicular filaments 71 maintain the integrity of the sheet during fabrication of the spiral element.

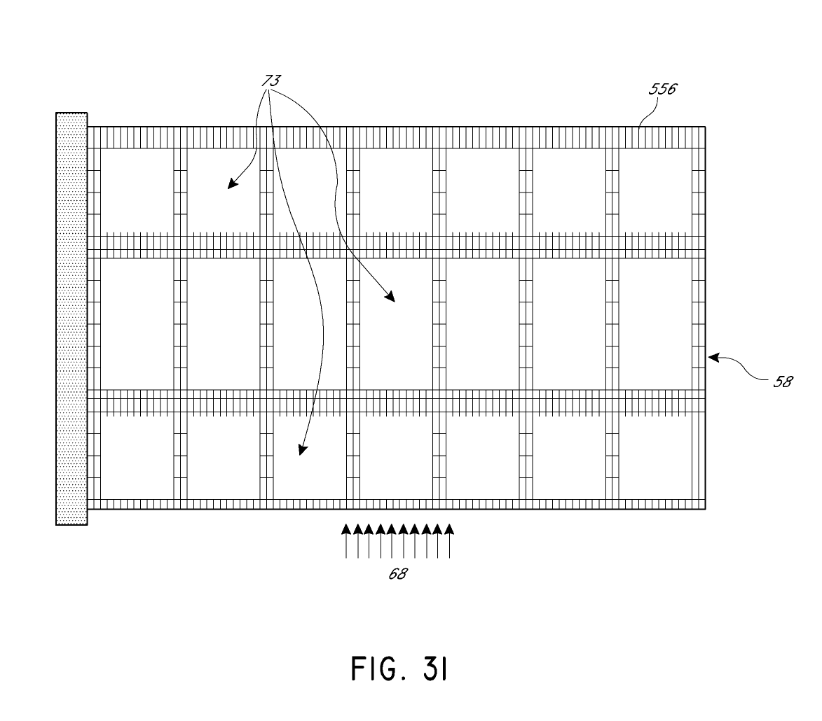

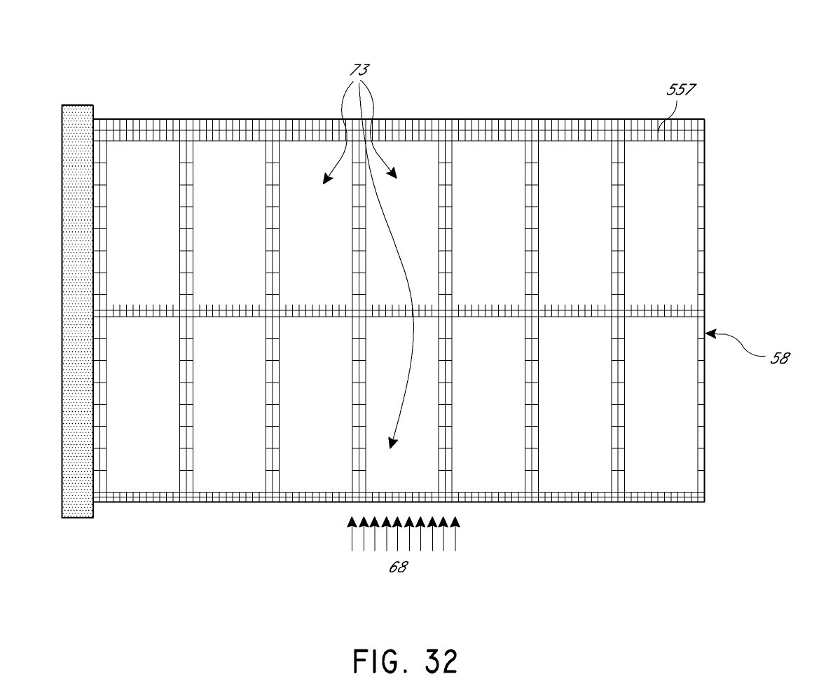

A preferred embodiment of the invention is shown in FIG. 31 where voids 73 are cut out of the feed spacer sheet 556. These voids 73 create areas where neither adjacent membrane film nor feed spacer sheet is touching the membrane surface. The width of each void may be less than 1 inch, at least 1 inch, at least 2 inches, at least 3 inches, at least 5 inches, or at least 10 inches. The length of each void may be less than 1 inch, at least 1 inch, at least 2 inches, at least 3 inches, at least 5 inches, or at least 10 inches. The voids may be shaped as rectangles or they may be square, circular, triangular, oblong, oval, or have a parallelogram shape. The lack of material touching the membrane 58 considerably lowers the fouling potential of the membrane. FIG. 32 shows another embodiment of the feed spacer sheet 557 with fewer, larger voids 73 cut from the sheet. This “window-pane” feed spacer sheet 557 can desirably minimize the opportunity for fouling by eliminating dead spots of low or no velocity. Further, the frequent change of velocity as the feed water travels over the spacer sheet from the open “pane” areas will impart turbulent flow further aiding the anti-fouling properties. In an exemplary embodiment, wherein the total area of the starting sheet for an 8″ diameter spiral wound membrane element is between approximately 1,500 and 2,500 square inches, the sheet provided with voids will have voids having a total area of at least 25 square inches, at least 35 square inches, at least 50 square inches, at least 65 square inches, at least 75 square inches, at least 85 square inches, or at least 90 square inches. In some embodiments, wherein the total area of the starting sheet for an 8″ diameter spiral wound membrane element is between approximately 1,500 and 2,500 square inches, the sheet provided with voids will have a minimum total area of the void areas of 40 square inches. In some embodiments, wherein the total area of the starting sheet for an 8″ diameter spiral wound membrane element is between approximately 1,500 and 2,500 square inches, the sheet provided with voids will have a maximum total area of the void areas of 100 square inches. In some embodiments, wherein the total area of the starting sheet for an 8″ diameter spiral wound membrane element is between approximately 1,500 and 2,500 square inches, the sheet provided with voids will have voids having a total area between 20 and 120 square inches, between 40 and 100 square inches, between 45 and 90 square inches, between 50 and 80 square inches, and between 60 and 70 square inches. In some embodiments, wherein the total area of the starting sheet for an 8″ diameter spiral wound membrane element is between approximately 1,500 and 2,500 square inches, the sheet provided with voids will have a maximum dimension of the void areas of 150 inches. In some embodiments, wherein the total area of the starting sheet for an 8″ diameter spiral wound membrane element is between approximately 1,500 and 2,500 square inches, the sheet provided with voids will have a minimum dimension of the void areas of 20 inches. In some embodiments, wherein the total area of the starting sheet for an 8″ diameter spiral wound membrane element is between approximately 1,500 and 2,500 square inches, the sheet provided with voids will have voids having a length or diameter of each void area of at least 1 inch, at least 5 inches, at least 10 inches, at least 15 inches, at least 20 inches, at least 30 inches, at least 40 inches, at least 50 inches, at least 65 inches, at least 75 inches, at least 85 inches or at least 95 inches. For larger or smaller sheets, the total areas of voids and materials will be adjusted up or down, while maintaining similar ratios. In some embodiments, the ratio of feed spacer material to void areas is 1 unit of area of feed spacer to 1-8 units of area of void. In some embodiments, a lower ratio can be desirable, in other embodiments, a higher ratio can be desirable.

The above description presents the best mode contemplated for carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above that are fully equivalent. Consequently, this invention is not limited to the particular embodiments disclosed. On the contrary, this invention covers all modifications and alternate constructions coming within the spirit and scope of the invention as generally expressed by the following claims, which particularly point out and distinctly claim the subject matter of the invention. While the disclosure has been illustrated and described in detail in the drawings and foregoing description, such illustration and description are to be considered illustrative or exemplary and not restrictive.

All references cited herein are incorporated herein by reference in their entirety. To the extent publications and patents or patent applications incorporated by reference contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Where a range of values is provided, it is understood that the upper and lower limit, and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article ‘a’ or ‘an’ does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases ‘at least one’ and ‘one or more’ to introduce claim recitations. However, the use of such phrases should not be construed to imply that the introduction of a claim recitation by the indefinite articles ‘a’ or ‘an’ limits any particular claim containing such introduced claim recitation to embodiments containing only one such recitation, even when the same claim includes the introductory phrases ‘one or more’ or ‘at least one’ and indefinite articles such as ‘a’ or ‘an’ (e.g., ‘a’ and/or ‘an’ should typically be interpreted to mean ‘at least one’ or ‘one or more’); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of ‘two recitations,’ without other modifiers, typically means at least two recitations, or two or more recitations). Furthermore, in those instances where a convention analogous to ‘at least one of A, B, and C, etc.’ is used, in general such a construction is intended in the sense one having skill in the art would understand the convention (e.g., ‘a system having at least one of A, B, and C’ would include but not be limited to systems that have A alone, B alone, C alone, A and B together, A and C together, B and C together, and/or A, B, and C together, etc.). In those instances where a convention analogous to ‘at least one of A, B, or C, etc.’ is used, in general such a construction is intended in the sense one having skill in the art would understand the convention (e.g., ‘a system having at least one of A, B, or C’ would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase ‘A or B’ will be understood to include the possibilities of ‘A’ or ‘B’ or ‘A and B.’

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

1.-35. (canceled)

36. A system for treating liquid comprising membrane foulants, the system comprising:
a cylindrical pressure vessel configured to hold a volume of a liquid comprising membrane foulants, the cylindrical pressure vessel having an inlet, a concentrate outlet, and a permeate outlet;
a plurality of spiral wound membrane elements disposed within the cylindrical pressure vessel; and
a pump configured to circulate the liquid in the cylindrical pressure vessel in a direction generally parallel to a membrane surface of the membrane elements,
wherein the plurality of spiral wound membrane elements are arranged in a circular array vertically within the cylindrical pressure vessel and tangential to both adjacent spiral wound membrane elements and an interior wall of the cylindrical pressure vessel such that the plurality of spiral wound membrane elements are arrayed surrounding a circulation return, such that the system is configured so that the liquid flows in a first direction through the circulation return and in a direction opposite to that of the first direction through the plurality of spiral wound membrane elements.

37. The system of claim 36, wherein the circulation return is a cylindrical-shaped central flow path not containing a spiral wound membrane element.

38. The system of claim 36, wherein each spiral wound membrane element has a first end and a second end.

39. The system of claim 38, wherein the first end of each of the spiral wound membrane elements is disposed proximal to a cover of the pressure vessel and the second end of each of the spiral wound membrane elements is disposed proximal to a bottom surface of the pressure vessel.

40. The system of claim 36, wherein each of the plurality of spiral wound membrane elements is an osmotic polymeric thin film composite membrane element.

41. The system of claim 36, wherein the pressure vessel further comprises baffles configured to direct a flow of the liquid to the pump.

42. The system of claim 36, wherein a first plurality of spiral wound membrane elements are stacked vertically on a second plurality of spiral wound membrane elements.

43. The system of claim 42, wherein twelve total spiral wound membrane elements are disposed within the pressure vessel in two stacked levels.

44. The system of claim 36, wherein the plurality of spiral wound membrane elements are arranged in three concentric arrays surrounding the circulation return.

45. The system of claim 44, wherein at least twenty-one spiral wound membrane elements are disposed within the pressure vessel.

46. The system of claim 36, wherein a diameter of the circulation return is at least one half of a diameter of the pressure vessel.

47. A spiral wound membrane element configured for water treatment, comprising:
at least one membrane leaf connected to a perforated permeate collection tube, the membrane leaf having a membrane surface; and
a spacer element disposed adjacent to the at least one membrane leaf and configured to keep the membrane surface separated from adjacent membrane surfaces when the membrane leaf is wound,
wherein the spacer element further comprises a pattern of voids such that the voids create areas within the membrane element where neither adjacent membrane surfaces nor the spacer element touch the membrane surface.

48. The spiral wound membrane element of claim 47, wherein the voids create a window-pane pattern.

49. The spiral wound membrane element of claim 47, wherein the voids are rectangular.

50. The spiral wound membrane element of claim 47, wherein the voids are oval-shaped.

51. The spiral wound membrane element of claim 47, wherein the voids have a total area of at least 90 square inches.

52. A method of treating an aqueous liquid containing membrane foulants, the method comprising:
periodically adding antifouling particles to a liquid containing membrane foulants, the antifouling particles having a specific surface area of 10 m²/g or more;
supplying the liquid to a pressure vessel, the pressure vessel having an inlet, a concentrate outlet, a permeate outlet, and a plurality of spiral wound membrane elements vertically and tangentially disposed in a circle within the pressure vessel surrounding a circulation return;
applying a pressure differential across the spiral wound membrane elements;
circulating the liquid past the spiral wound membrane elements in the pressure vessel; and
collecting permeate from the permeate outlet.

53. The method of claim 52, wherein adjacent membrane leaves of the membrane elements are separated by a spacer element having a window-pane pattern.
